(19) United States
(12) Patent Application Publication
(10) Pub. No.: US 2020/0160263 A1
(43) Pub. Date: May 21, 2020

(54) System, Method, And Packaging For Secure Food Delivery

(71) Applicant: Marcus Kuettner, Langley (CA)

(72) Inventor: Marcus Kuettner, Langley (CA)

(21) Appl. No.: 16/676,345

(22) Filed: Nov. 6, 2019

(30) Foreign Application Priority Data
Nov. 6, 2018 (CA) 3023307
Nov. 7, 2018 (CA) 3023375
Aug. 15, 2019 (CA) 3052185

(51) Int. Cl. G06Q 10/08

(52) U.S. Cl. CPC G06Q 10/0832

(57) ABSTRACT

A computer-enabled internet-based platform enables a system, method and tamper proof packaging to be combined to validate when a food delivery is completed with the secure delivery of a food order. The system is managed by a third-party validator that establishes processes and procedures followed by the food source and the customer, and validation of the secure delivery of a food order is confirmed automatically by a server managed and operated by the third-party validator. The server maintains a digital database that is used to check if a unique identifier attached to a food order sealed in the tamper proof packaging is the same unique identifier that was attached to the food order when it was sealed inside the tamper proof packaging at the food source. The server is programmed to make this validation based on data inputs submitted by the food source and the customer through respective user interfaces connected to the internet that were designed and provided to the respective users by the third-party validator.

### FIELD OF THE INVENTION

The present application relates to a system, method, and packaging that together cooperate to provide a universal platform for secure food delivery. More particularly, this universal platform provides a system and method that enables third-party validation that the secure food packaging is the same packaging the food order was originally sealed inside at a food source, and the secure food packaging gives consumers who order food deliveries confidence that their food items have not been tampered with while being delivered to them.

### BACKGROUND OF THE INVENTION

In many places it is not uncommon for consumers to order food deliveries from grocery stores and restaurants. Traditionally, deliveries were made by employees of the business selling the goods. If it was a pizza restaurant the restaurant had staff that delivered the pizzas. If it was a grocery store, some grocery stores had delivery trucks with drivers employed by the grocery store. In these scenarios, consumers develop a sense of trust because the delivery people are employed by the business that is selling the food. A business values its reputation, so it has an interest in making sure that its delivery people are trustworthy and that their customers get what they paid for without any tampering. If a customer has a complaint, the customer can contact the business and hold it accountable. Delivery people who do not provide good service can be terminated so that a high standard of service is maintained. Such purchases are usually made from a local business and consumers can even develop a familiarity with the delivery person. Consumers have come to expect a minimum duty of care from businesses and tampering of food deliveries has not been a problem associated with this traditional food delivery model.

These days, a new food delivery model has been introduced. Consumers have become accustomed to ordering products on-line and having them delivered by independent delivery services. This business model is now being applied to food delivery. Internet-based retailers have purchased traditional grocery stores and have announced that they wish to deliver groceries to their customers. Many companies, such as Uber Eats™ (launched in 2014), Skip the Dishes™ (founded in 2012) and Foodora™ (founded in 2015) are businesses that offer food delivery services from restaurants. Such services are becoming more popular since they offer the consumer variety, convenience and time saving advantages. Many restaurants who did not previously offer delivery services can now access a broader market and serve more meals per evening than their dining rooms can accommodate. This can make restaurants more profitable without expanding the capacity of their dining rooms, which reduces overhead costs per customer served. While there are many advantages and benefits associated with this new model for home delivery, many of the conditions that were present in the past with traditional food delivery, that helped to provide security and instill trust in the customers, are missing with the new model.

With the growth of third-party food delivery services, the risk of food being tampered with has increased. However, there is no universal way for securing food deliveries so that any tampering that compromises the security of the food will be obvious and visible to the customer that ordered the food. Food delivery services often hire casual workers who operate more like independent contractors than employees. Incidents are starting to occur where consumers who have had their food delivered, suspect that the food has been tampered with. There have been instances reported where food appears to be missing or partly eaten but it can be hard for the consumer to prove it and even harder to prove who did it. With a third-party delivery service, the person making the delivery could be a different person each time, so there is not the same level of trust. If the delivery person is making more than one delivery and the food is carried in a single thermally insulated carrier, and if the food containers accidentally open, the food could get contaminated or mixed with other food in the carrier. The delivery person might also use the carrier to carry other things, not just other food being delivered, but also the delivery person's own personal items, that could contaminate the food. Some delivery services use people who ride bicycles, and this could result in more jostling of the food items inside a carrier mounted on the bicycle or carried on the back of the delivery person. It is hard for consumers to discern from appearance of the food in the container whether it has been disturbed by tampering or just shaken when in transit. If the delivery person is delivering more than just food, and if the food containers can be opened by the delivery person, he or she could hide or bundle things together and forget to separate the bundled items. For example, a delivery person could also be delivering illegal substances on the same delivery route. Bundled items could contaminate each other. This can be especially dangerous if a consumer has food allergies and food is contaminated by something that the consumer is allergic to, or worse, the food could be contained by an illegal substance. In addition, there is always the danger that the delivery person could intentionally contaminate the food because of a feud or dislike of the consumer by the delivery person. Perhaps the consumer is a bad tipper or someone that the delivery person knows and dislikes for any number of reasons. Some consumers might wonder if the delivery person spat into the food or otherwise contaminated it. Perhaps the delivery person is just unreliable, irresponsible and/or dishonest. In other cases, the delivery person might unknowingly (or knowingly) have an infectious disease, and the consumer is better protected by preventing any contact between the delivery person and the food being delivered. For food deliveries from grocery stores, a customer could order two kilograms of apples, but customers seldom weigh their groceries when they receive them, so a customer might not notice that an apple is missing.

The concept of protecting food deliveries against tampering is not by itself novel. However, solutions to date have limitations and have drawbacks that inhibit them from being adopted universally. For example, there have been numerous attempts to improve the packaging for pizza to make the it hard to tamper with the food. Even before the introduction of independent food delivery services, many pizza restaurants offered delivery services. Even with deliveries made by employees, there was a need to improve the packaging for pizza to make them more resistant to tampering. For example, US Patent Application Publication No. 2017/0362008A1 discloses tamper resistant food container that has an adhesive strip that securely seals the box lid in a closed position. The box is opened by ripping a tear-away strip to lift the lid. This ensures that the pizza box cannot be opened by the delivery person without the customer seeing that the box has been opened. US Patent Application Publication Nos. 2016/0304234A1 and 2016/0304235A1 show a similar concept with a plastic cord or string that is pulled to tear the food container open along a perforated line. These patent applications illustrate this feature for pizza boxes as well as other food containers, such as clam shell designs, cartons, and paper bags. US Patent Application Publication No. 2015/0183558A1, shows a pizza box that includes an integrated locking system. The box has what appear to be straps that are attached to the bottom portion of the box and that can be sealed to the lid or upper portion of the box, to prevent the box from being opened without breaking the seal or straps. While these approaches reduce the likelihood of the contents of the food container being tampered with, a disadvantage of all these solutions is that they all require a special container. Conventional pizza boxes would need to be replaced with new pizza boxes that have the tamper proof features. None of these sealed pizza boxes prevent anyone from tampering with the food and then transferring it to a freshly sealed pizza box. If a restaurant currently uses Styrofoam® food containers, aluminum food containers, or plastic food containers, it would also need to change the type of food containers that it uses. Containers with the tamper proof features might not be available in the area where a business is located. Tamper proof containers might be more expensive than conventional food containers. Using tamper proof food containers might also require a business to change to a different supplier, and this could be a problem if a business has a long-term supply agreement with its existing supplier. Some of the patented tamper proof food containers might not be available for purchase or license if the patent owner wishes to use it for itself exclusively, to differentiate itself from competitors. For these solutions that use a sealed package, without any third-party verification, there is no guarantee that the delivery person has not tampered with the food and then re-sealed it with a new seal, or re-packaged it in a new sealed package.

There have also been developments directed to food packaging for carrying cups. Beverages are often part of a food order and traditional cups for holding beverages are not normally sealed from being opened. Traditional cup carriers are known for enabling one person to carry of a plurality of cups. Ease of use by the vendor and the customer has been the objective of such carriers. Such carriers are normally used by customers themselves, for example trays with recessed pockets shaped to receive cups or circular holes can be used to carry beverage-filled cups from a concession stand to a seat in a stadium, or for a consumer to carry a take-out order from a restaurant to a work place or home. It can be difficult to carry tall cups in these types of trays, if the cups are susceptible to tipping over. U.S. Design Pat. No. D655,207, entitled “Beverage Cup Carrier”, offered an improved tray that adds a handle in the middle. Tray-type cup carriers provide no means of securing the contents of the cups from the person carrying them.

Some cup carriers are for a specific application and are not universally usable for a wide variety of cup shapes and sizes. Cups can vary in the degree of their taper, affecting their diameter, and can also vary in their height, for example there can be a range of cup sizes and shapes from small to extra-extra large. U.S. Pat. No. 3,661,417 entitled “Carrier and Foldable Blank for Making Same” is an example of a cup carrier that is designed to carry a specific size and style of cup. It discloses a paperboard blank that is foldable into a cup carrier that has hole cut-outs shaped to receive cups that are to be carried. In the illustrated example, the cups have a circular bottom but at the upper rim of the cup, it has a larger cross section that is still rounded but no longer circular. In the illustrated example near the top, the cups have a predominantly three-sided cross section rather than a circular one. The rim of the cup is rolled to have a bead that is an enlarged portion that will not pass through the hole cut-out. In this way the cup carrier uses the bead of the cup to support it. When folded, the tops of the cups are covered, but the carrier is not sealed, and it would be easy for anyone to release the tabs from the assembled carrier to fold back the top panels without any obvious indication that this has been done. Accordingly, the drinks are not well secured against tampering or access by the delivery person, who might be thirsty.

For vendors, to facilitate ease of use, a feature of some designs has been that they can be assembled quickly by folding along creased lines and without the use of any adhesives, using only slots and hook-shapes to releasably hold the carrier in its assembled shape. Korean Patent No. 101366687 B1 discloses an example of such a carrier. The disclosed carrier is foldable to form a handle that folds up from two top sheets that cover the tops of the cups. Tabs on the side fold up to hook onto the handle, to hold the two halves of the handle together. In addition to being easy to assembly, it is also easy for the consumer to unhook the sides and gain access to the cups. Such designs pre-date the advent of the introduction of food delivery services that use casual contractor labor for food deliveries, and carriers like this teach away from a carrier that is tamper proof or tamper-evident that prevents access to the contents of the cup(s) without any evidence of tampering. United States patent application US 2003/0071045 A1 was conceived in 2001, prior to the popularity of third-party food delivery services and while the disclosed cup carrier does facilitate the carrying of a plurality of cups, it is mainly directed to a carrier that can be adaptable to more than one assembled configuration for different needs or for adaptation by the customer at different times, for example to assist the customer in one configuration for carrying the cup and to be re-configured in another way for holding the cup while drinking. Accordingly, it teaches away from any features for sealing the cup(s) in a tamper-proof or tamper-evident carrier configuration for secure transportation by someone other than the customer. The re-configurability of the carrier teaches away from sealing the carrier in a carrying configuration.

With carbonated beverages, after some of the gas dissipates from the liquid the cup may not be full when delivered, even if filled to the top at the restaurant, so this makes it hard to prove that a drink has been tampered with. If a customer is suspicious that a beverage delivered in an unsealed and unsecured carrier has been partly consumed or otherwise tampered with, it can be hard for the consumer to prove it and even harder to prove who did it, especially if the delivery person can offer other plausible and innocent explanations for why the cup is not full.

Known cup carriers do not disclose a cup carrier that can be easily and quickly assembled, that can carrying a plurality of cups, that is flexible for carrying cups of different sizes at the same time, and that provides a closed sealed space around the tops of the cups to prevent access thereto without visible evidence of tampering.

U.S. Pat. No. 7,243,785, entitled “Carrier and Method” discloses a two-piece carrier that can carry both food and beverages. One piece has hole cut-outs or compartments and is folded to form a cup carrier. A second piece is folded into a food tray that slides down the handle of the cup carrier so that the one handle can be used to carry both beverages and food. While one paperboard sheet blank could be used for both pieces, this method still requires folding two pieces and if one piece is used more often than the other pieces, then the restaurant could be left with too many food trays or too many cup carriers. An ideal use for such a carrier might be bringing a family-sized food and drink order from a concession stand to seats in a stadium. However, like the other known prior art, this design does not secure the food and drinks against tampering by a delivery person. With this design, the food and drinks are all accessible to the delivery person and the drinks are not secure against tampering, unauthorized access and contamination from contact with other food or unsanitary exposure while being delivered.

US Patent Application Publication No. 2018/0162603A1 discloses a sealable plastic bag assembly. This allows food to be delivered in conventional containers, and then the bag is sealed so that if it is opened before it is delivered to the customer, the customer will be able to see that the sealed bag has been opened. UK Patent No. GB 2,401849B is an example of a similar approach, where additional packaging receives the food containers with this packaging being heat sealed to prevent access to the food during delivery. While these approaches allow restaurants to continue to use their conventional food containers, it requires the purchase of additional packaging in the form of special bags or other packaging. If the sealed packaging is single-use, this is not a solution that would appeal to people concerned about their environmental footprint and increasing the amount of waste. If the size of food orders varies from customer to customer this might require a business to purchase different sized bags. Someone trying to circumvent this security measure could have extra bags and re-seal the food in a new bag before delivering it to the customer. If the packaging is heat sealed, then this requires the business to purchase a heat-sealing machine. While such approaches would make it more difficult for the food to be tampered with, there are still disadvantages for businesses and without third-party verification to assure customers that there has been no tampering, there are still shortcomings that could cause some customers to remain concerned about the security of their food.

As these examples show, there have been solutions in the past directed at specific packaging, but there has been no platform that combines a system, method, packaging and third-party validation for universally securing food deliveries that are delivered in conventional packaging, and for giving the customer more certainty that the food has not been tampered with. There is a need for a secure and universally implementable food delivery platform that enables consumers to order food deliveries and be confident that the delivered food has not been tampered with between the time when it was packaged by the restaurant or grocery store and the time when it is delivered to the consumer. Even if tampering incidents are infrequent, there are some consumers who will not feel comfortable using a food delivery service so long as there is a risk of tampering, no matter how small the risk may be. For restaurants, grocery stores, and delivery companies, without universally available methods for securing food against tampering, they are exposing themselves to risks, for example, if a consumer gets sick or even dies from eating tampered food. All these businesses could have their reputations damaged and their business could suffer irreparable harm if consumers become victims of food tampering and/or contamination. With conventional methods, if there is a problem it might not be possible to ever prove with certainty who caused the problem. For example, the food could have been contaminated or prepared incorrectly at the source and not by the delivery person. If a customer gets sick from a food delivery, that customer might never again order food from the same restaurant, but the problem could have been caused by the delivery person, not by the restaurant. In other circumstances a customer that gets sick might stop ordering food delivery from all food sources and this is a loss to both food sources and food delivery services. Even if a food delivery service can later prove that the food was contaminated at the source, or if the restaurant is able to prove that it was the food delivery person who caused the problem, the damage to the innocent business has already been done and it could be difficult to reverse the damage to its reputation. This harm may not relate to just the unhappy customer. With the use of social media today, consumers often give ratings and warnings about restaurants. If a consumer receives tainted food and complains about it on social media and/or consumer review sites like Yelp™ or Trip Advisor™ this could be very harmful to a business and unjustified if the tainting was caused not by the restaurant, but by the delivery person. That is, one bad incident caused by tampering by a delivery person could have broader implications than just the loss on one customer, since many consumers now rely on restaurant reviews and social media when choosing a restaurant for ordering food.

The need to be addressed is most problematic for food delivered from a food source to a customer by means of a third-party delivery service. Third-party delivery services are common-place now, but this business model has only become widely used in the last 10 years and the problems associated with it, such as securing food during delivery, is a relatively new and heretofore unaddressed problem, to the applicant's knowledge. However, if customers become accustomed to a more secure platform for food delivery that is tamper proof or tamper evident, then customers could see value in such delivery methods even when the delivery is not made by a third-party. For example, the solution to this problem could also be applied to give customers assurance that the delivered food has not been tampered with or otherwise compromised even when the delivery is made by employees of the food source, such as grocery store delivery people, the people delivering room service food orders to hotel or motel guests, or a pizza delivery person that works for a pizza restaurant. Even though some of these delivery people might ordinarily be trusted, in a large operation such as a large hotel, a large restaurant franchise, or a large grocery store chain, a method of securing the food during delivery gives the customer extra assurance that the food that was packaged was not accessed during transit, especially if the security of the food packaging can be verified by a third-party validator.

Accordingly, there is a need for a universally available platform that combines features for a novel system, method and packaging for securing food deliveries to consumers, that enables consumers to be confident that the food delivered to them has not been tampered with, or contaminated by improper handling while being delivered. Businesses that make the food or that handle the deliveries can also benefit from a platform that provides independent verification that the food being delivered has not been tampered with. The assurance of secure delivery of food can be a factor that consumers use in choosing a food source for home delivery. That is, businesses that offer a method of giving consumers verification against tampering by an independent third-party validator can offer this as an added value that differentiates them from their competition. Businesses involved in the delivery of food will also benefit if secure delivery processes result in more people ordering food deliveries.

### SUMMARY OF THE INVENTION

A universal computer-enabled web-based platform is disclosed for securing food delivery from a food source that sells food that is delivered to a customer. The computer-enabled web-based platform comprises a combination of features afforded by a system, method, and secure packaging.

The computer-enabled web-based method operates in the context of customers ordering food for delivery from a food source. A third-party validator establishes a platform that includes processes and procedures for securing food orders from tampering by training food sources in these processes and procedures and requiring food sources to use tamper proof seal devices that have a unique identifier than is permanently marked thereon, or on secure packaging, or on a tag integrated with the tamper proof seal device. The tamper proof seal device and the secure packaging ensure that the food is not tampered with between leaving the food source and being delivered to the customer. The food source keeps an inventory of unique identifiers that have been assigned to the food source by the third-party validator, which maintains a digital database of all of the unique identifiers that have been assigned to food sources. The third-party operates and controls one or more servers which maintain the digital database and a processor on the server operates according to a set of instructions to automatically administer over the computer-enabled web-based platform, method and system. The third-party validator creates a food source interface that is loaded onto a food source computer. When the food source receives a food order for delivery, the food source prepares the food order and packages it according to the processes and procedures established by the third-party validator. This entails sealing the food order in tamper proof packaging and sealing it with a tamper proof sealing device. The unique identifier is permanently associated with the tamper proof packaging or the tamper proof seal device which is then associated with the food order. With the food sealed inside the tamper proof packaging, the food source uses the food source interface to upload a unique identifier to the third-party validator's one or more servers. The unique identifier can be in the form of a code comprising letters, number and/or keyboard symbols, a bar code, a QR Code, or another machine readable code, and the unique identifier can be entered into the food source computer by scanning, photographic capture, or manually entered through a computer keyboard that can be mechanical or electronic. The food source user interface communicates the unique identifier to the third-party validator server and the processor is programmed to compare the uploaded unique identifier with the unique identifiers in the digital database. If the processor determines that the unique identifier matches a unique identifier in the digital database that was assigned to the food source, and that it is valid, the processor communicates to the food source user interface that the unique identifier has been approved for deployment and is now associated with the food order inside the sealed package. When the food order is delivered to the customer, the customer inspects the sealed package to be sure that it has not been tampered with. If there are no visible signs of damage to the packaging or the tamper proof seal device then the customer opens a customer user interface operating on a customer computer. The customer user interface is provided by the third-party validator and it enables the customer to use his or her computer to communicate with the third-party validator's server using a communication network such as the internet. The one or more processors that are part of the third-party validators one or more servers receives the unique identifier reported by the customer, which was entered into the customer's computer using the customer user interface, for example, by using photographic scanning or manual keyboard entry. The processor compares the unique identifier with the unique identifier uploaded by the food source and marked by the processor in the digital database as being deployed for the customer's food order. If the unique identifiers match, then the processor automatically provides third-party validation that the food order was delivered securely, and the processor marks the status of the unique identifier in the digital database as “used: so that the unique identifier cannot be used again.

The food source can be any business that prepares food that is ordered by a customer for delivery to a location designated by the customer. Examples of food sources, without limitation, include restaurants, coffee shops, cafes, ice cream shops, farms, ranches, organic food stores, marijuana dispensaries, and grocery stores.

In some embodiments, the food source can receive the food order from the customer through an intermediary business. The intermediary business can be a service provider that arranges food deliveries from pre-selected food sources that have agreed to apply the tamper proof seal device at the food source. The intermediary business can also coordinate people making the deliveries. It is important to the integrity of the method and for the confidence of the customers in the security of the platform that the intermediary business and none of its employees or contractors handle the packaged food until after it is sealed in the tamper proof packaging sealed with a tamper proof seal device.

The database that is managed by a third-party validator gives an independent validation to customers that the unique identifier on the tamper proof seal device or packaging matches the unique identifier uploaded by the food source and that is validated according to the processes and procedures established by the third-party validator. Normally the unique identifier is reported to the third-party validator as already described, but in alternative embodiments the third-party validator can make the unique identifier available to the customer through the customer user interface. This can be done automatically if the customer has a customer profile saved with the third-party validator so that the customer's identity is known and verified. In another embodiment the customer can communicate with the one or more servers to retrieve the unique identifier by providing information about the food order, or a verification code automatically given to the customer by the foods source when the customer ordered the food. With these embodiments the customer can immediately validate that the food order has been delivered securely when the food is delivered and that the correct food order is being delivered. In other embodiments, the food source automatically sends the unique identifier directly to the customer, for example by a text notification, e-mail, phone call or other notification method chosen by the customer. With embodiments where the customer receives the unique identifier from the food source or from the third-party validator, it is still important for the unique identifier to be reported to the third-party validator because the status of the unique identifier needs to be tracked in the digital database to protect the integrity of the unique identifiers and to ensure that used unique identifiers cannot be used again. The automation in the system and the scale of data that needs to be managed in real time and that must be managed remotely across a communication network requires that the method be compute-enabled.

That is, in addition to automated managing the digital database in real time by one or more processors, the role of a third-party validator includes giving the customer confidence that there is independent oversight to check that a process is being followed by the food source to ensure that the food is packaged and sealed according to a process prescribed by the third-party validator, so that there are ample safeguards against tampering.

In some embodiments of the method, the third-party validator and the food source enter into an agreement to agree to at least one of: (1) supply of tamper proof seal devices with pre-printed unique identifiers, supplied from the third-party validator to the food source, enabling the third-party validator to maintain control over all of the unique identifiers assigned to each food source and to keep an accurate record in the digital database of all of the unique identifiers assigned to the food source; (2) payment from the food source to the third-party validator to contribute to funding the management of the platform the servers and the digital database; (3) access to the digital database, granted to the food source by the third-party validator to upload the unique identifiers when deployed, and for permitting the food source's customers report the unique identifiers associated with received food orders or to communicate with the server to retrieve the unique identifiers assigned to the customers' respective food orders; and (4) supply of tamper proof seal devices and/or secure packaging that is designed to provide a secure enclosed space that facilitates sealing to deter access to the package contents by preventing access without visible damage to a tamper proof seal device or the packaging.

In preferred embodiments the database is cloud-based, meaning that the cloud database is delivered as part of the service provided by the third-party validator to food sources and customers. The third-party validator manages back-end processes associated with the database installation, deployment, data management and resource assignment tasks. As part of the platform, the third-party validator makes tools available to food sources, such as a web interface and/or user application for uploading the unique identifier and other data associated with food orders. The third-party validator can also make tools available to customers, also as part of the platform, such as a customer application for a smart phone or other device to allow them to communicate with the server to report the unique identifier or access the database and retrieve the unique identifiers associated with their respective food orders.

An important feature of preferred embodiments of the method is the contractual relationship between the third-party validator and the food source, because it can include terms that define the process to be followed by the food source that will give customers confidence that the food delivered from that food source will be secure from tampering during delivery. For example, the contract between the third-party validator and the food source can stipulate that the food source agrees to give the third-party validator the right to inspect the food source's facilities to ensure that the food source is correctly applying the tamper proof seal labels to seal the food containers before they are given to the delivery service. The terms of the contract can further include an agreement that the food source will purchase the tamper proof seal devices with pre-printed unique identifiers from the third-party validator or one of its licensed and authorized distributors or vendors. This ensures that there is quality control and that the tamper proof seal devices will have unique identifiers that are given by a third-party validator, without any opportunity for tampering at the food source. This customer confidence can still be maintained if the third-party validator grants a license to a food source to print its own unique identifiers onto tamper proof seal labels that the food source purchases from the third-party validator if the license includes terms that require the food source to follow processes to prevent any duplication of the unique identifiers, so that replacement labels cannot be generated and so that food is kept secure from tampering. Some elements of the platform and method can be licensed. For example, the food source can be permitted to use its own unique format for the unique identifier provided that the chosen format has been pre-approved by the third-party validator so that they are not the same as other unique identifiers assigned to other food sources by the third-party validator. The third-party validator must have final approval over the format and still maintains a comprehensive digital database of all of the unique identifiers issued by itself and licensees to ensure that they are indeed unique, allowing the third-party validator to be able to confirm that each unique identifier is authentic. Unique in this context means that at a given point in time, a unique identifier is only available for deployment by one food source. Since some tamper proof seal devices such as adhesive labels are destroyed after the food container is opened, and their tamper proof characteristics ensure that they cannot be re-used after one use, after a predetermined period of time, so long as none of the unique identifiers in a series were lost or otherwise unaccounted for, if every unique identifier in a series of unique identifiers was either used or spoiled and accounted for as such, a third-party validator that is managing the assignment of unique identifiers could choose to re-use a series of unique identifiers without risk of the same unique identifier being borne by more than one food container at the same time, and so long as the previously used unique identifiers are archived and removed from the third-party validator's digital database.

In some embodiments, the unique identifier is in machine readable form, whereby it can be entered into the database by being electronically scanned or photographed. If in machine readable form, it can be in a bar code, QR Code or some other coded form. The ink or toner that is used to print the code can be magnetic, for example, by containing iron oxide. In some embodiments the code can be translated into a format that consists of some or all of n alpha-numeric and/or keyboard symbols so that the code can be communicated by text and entering into a computer manually, without a scanner or camera. A magnetic ink character recognition (MICR) code is an example of a code standard that uses magnetic ink and because these codes are normally numeric, they can be easily read by people and put into a text message or entered manually into a computer using a keyboard. In other embodiments, an application can be installed on the customer's smart phone so that the phone's camera can scan the code and confirm that it is the same code that is associated with the seal label that was applied at the food source to seal the food container. Other types of codes and technologies can be substituted to function in substantially the same way to achieve substantially the same result. For example, instead of printing with ink the unique identifier can be laser etched. In yet another example the seal labels can further incorporate radio frequency identification RFID technologies that use electromagnetic fields to automatically identify and track food containers.

In embodiments of a tamper proof seal label, this type of tamper proof seal device can comprise a paper or plastic sheet label with an adhesive backing with tamper proof features, so that once applied to the packaging, the tamper proof seal label cannot be removed without tearing, deforming, or some other evidence of damage to the tamper proof seal label. With this embodiment, the unique identifier can be imprinted on the tamper proof seal label, which can then be applied to the packaging at a location that prevents the opening of the packaging without damaging the tamper proof seal label. In other embodiments, the tamper proof seal device can comprise a locking device that cannot be opened by anyone other than the customer without evidence of damage. The unique identifier can be printed on the locking device itself or on a tag or tab that is a display panel integrated with the locking device. By way of example, the locking device can comprise a self-locking loop with a flexible stem section that engages with a receiving head that comprises ratcheting features whereby when the stem section is inserted into the receiving head the stem section cannot be pulled out of the receiving head without evidence of damage. The self-locking loop can be made, for example, from nylon, and can be non-recycled or recycled plastic. For packaging that employs a double separating zippered closure, which has two opposed zipper sliders, such as a thermally insulated bag, the stem of the self-locking loop can be looped through the pull tabs for the opposing zipper sliders to seal the bag so that it cannot be opened without cutting the stem. In other embodiments, packaging can employ other closure arrangements that can be used to seal the packaging with a locking device. In other embodiments, the locking device can comprise a re-usable padlock with an electronic code or numeric combination that changed for each use. The instructions for opening the locking device can be automatically transmitted to the customer, when the customer uses the customer user interface to reports the unique identifier to the third-party validator. In this way, only the customer can open the padlock. In yet another embodiment the tamper proof seal device can consist of a cord that is looped through the packaging closure arrangement. The cord can be made, for example, from string or twisted paper, and can seal the packaging by locking the two ends of the cord between an adhesive-backed label that displays the unique identifier. In still another embodiment, the locking device can comprise a clamp that can be applied to seal the open side of a bag. In all embodiments, the tamper proof seal label displays a unique identifier that gives assurance to the customer that he or she can verify that the tamper proof seal label is the same one that was applied by the food source, and the tamper proof seal label is made in a form such that once applied to the packaging, the packaging cannot be opened without evidence of damage to the packaging or the tamper proof seal label.

The method can further comprise the third-party validator tracking the location of the food container when it is being delivered from the food source to the customer. For example, in a preferred embodiment, the third-party validator tracks the food container after the tamper proof seal label has been applied by having each person who handled the food container input the unique identifier into a device with GPS location tracking enabled and trackable by the third-party validator. The third-party validator can provide a driver app, which is a mobile application that gives a user interface to the driver for quickly scanning or otherwise entering the unique identifier into the driver's smart phone. The driver app can be programmed to use the GPS location data accessible by the smart phone so that once the unique identifier is entered into the driver app the third-party validator can track the location of food orders and share that with customers through the customer user interface. The delivery chain could include just one delivery person or a plurality of delivery people if the food container is handed off in the delivery process, and according to the method, whenever a person in this delivery chain takes possession of the food container that person inputs the unique identifier as part of the process for taking possession of the food container.

### BRIEF DESCRIPTION OF THE DRAWINGS

FIG. 1 is a diagram that illustrates a first embodiment of the universal method for secure food delivery.

FIG. 2 is a diagram that illustrates a second embodiment of the universal method for secure food delivery.

FIG. 3 is a diagram that illustrates a third embodiment of the universal method for secure food delivery.

FIG. 4 is a diagram that illustrates a fourth embodiment of the universal method for secure food delivery.

FIG. 5 is a flow chart that illustrates the steps in the process for the universal method for secure food delivery.

FIG. 6 is an illustration of a food container to which a tamper proof seal label has been applied.

FIG. 7 is an illustration of a second type of food container to which a tamper proof seal label has been applied.

FIG. 8 is an illustration of example of a third type of container to which a tamper proof seal label has been applied.

FIG. 9 illustrates an example of a zippered food container that can be sealed with a tamper proof seal label.

FIG. 9a illustrates an example of a tamper proof seal label that comprises a self-locking loop locking device.

FIG. 10 illustrates the food container of FIG. 9, sealed with a tamper proof seal label.

FIG. 11 illustrates a food container with a zippered closure that is sealed with a tamper proof seal label that is in the form of a padlock.

FIG. 12 illustrates a food container with a hasp latch that is sealed with a tamper proof seal label in the form of a padlock.

FIG. 13 is a perspective view of a food container with overlapping lid sections sealed with a tamper proof seal label.

FIG. 14 is a perspective view of a food container that is sealed with a tamper proof seal label in the form of a clamp.

FIG. 15 is an illustration of a clamp such as the one shown in FIG. 13, shown in a side view and in an open position.

FIG. 16 is an illustration of an alternative embodiment of a tamper proof seal label in the form of a clamp, shown in a side view and in an open position.

FIG. 17 is an illustration of a tamper proof seal label that employs a cord and an adhesive-backed label.

FIG. 18 is a cross section view of the cord and label of FIG. 16.

FIG. 19 illustrates the platform and system for the secure delivery of food orders.

FIG. 20 illustrates an alternative platform for the secure delivery of food orders with an intermediary business that manages the delivery of food orders.

FIG. 21 illustrates a first embodiment of a paperboard blank sheet for a carrier for secure cup delivery.

FIGS. 21A, 21B, 21C and 21D illustrate four different designs for the hole cut-out for receiving cups.

FIG. 22 illustrates an end view of the first embodiment of the carrier for secure cup delivery from FIG. 21, after being assembled.

FIG. 23 illustrates a second embodiment of a paperboard blank sheet for a carrier for secure cup delivery.

FIG. 24 illustrate a side view of the second embodiment of the carrier for secure cup delivery from FIG. 23, after being assembled.

FIG. 25 illustrates a third embodiment of a paperboard blank sheet for a carrier for secure cup delivery.

FIG. 26 illustrates an end view of the third embodiment of the carrier for secure cup delivery from FIG. 25, after being assembled.

FIG. 27 shows a side view of a re-usable cup carrier for secure cup delivery.

FIG. 28 is a side cross section view of an assembled cup carrier that shows an adapter ring for holding smaller cups.

FIG. 29 is a top view of the adapter ring of FIG. 28.

FIG. 30 is a side cross section view of an assembled cup carrier with a spacer for holding different cup sizes.

FIG. 31 is a perspective view of spacers of the type shown in FIG. 30.

FIG. 32 illustrates a fourth embodiment of a paperboard blank sheet for a carrier for secure cup delivery.

FIG. 33 illustrates a partial view of a fourth embodiment of a paperboard blank sheet for a carrier for secure cup delivery.

FIG. 34 illustrates an assembled side view of the embodiment of FIG. 33.

### DETAILED DESCRIPTION OF ILLUSTRATIVE EMBODIMENT(S)

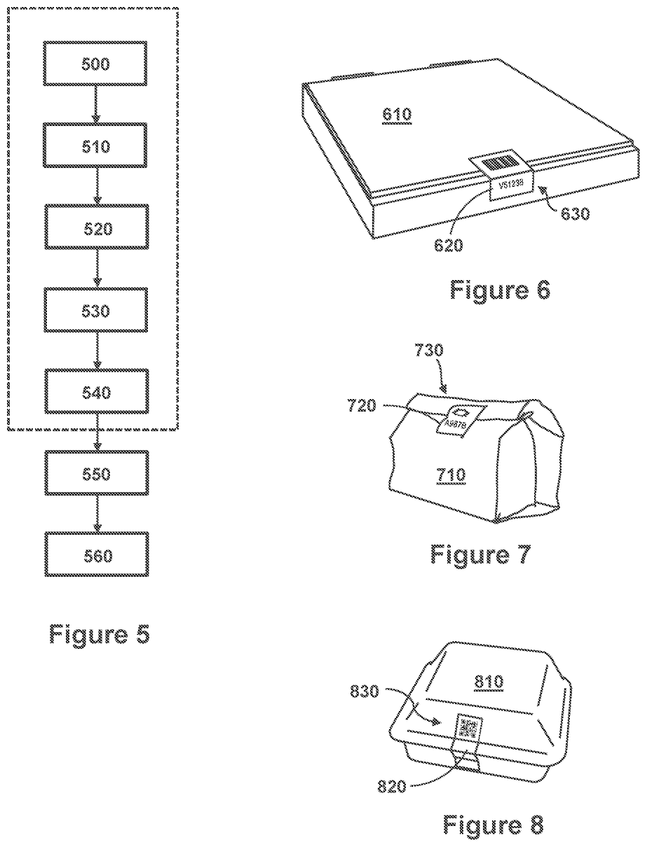

The following detailed description represents embodiments that are intended to provide an overview or framework for understanding the nature and character of the claims. The accompanying drawings are included to provide further understanding of the claims and constitute part of the specification. Accordingly, the detailed descriptions and drawings are non-limiting to the scope of what is claimed and are intended to illustrate and explain the principles and operations of these embodiments, as claimed. For example, the types of food containers that are illustrated in FIGS. 6 through 14 and FIGS. 21 through 34 are non-limiting examples. That is, these examples show that the tamper proof seal device can take many forms and can be applied to many types of food delivery containers and packaging which can be closed and sealed so that the food inside cannot be accessed without breaking the tamper proof seal device or damaging the container or packaging. The method is made universal by enabling restaurants and grocery stores to adapt the application of the tamper proof seal device to suit most conventional food containers or packaging before it is handed to the delivery person. In most cases, this allows businesses to continue to use the same containers and/or packaging that they are currently using, augmented with a tamper proof sealing device or combined with tamper proof packaging that provides better security to better protect the delivered food from being tampered with from the point where the food is packaged, to point where it is delivered to the customer. For example, in some embodiments conventional food containers can be placed inside cooler bags or other packaging that provide more security by being sealable with a tamper proof seal device.

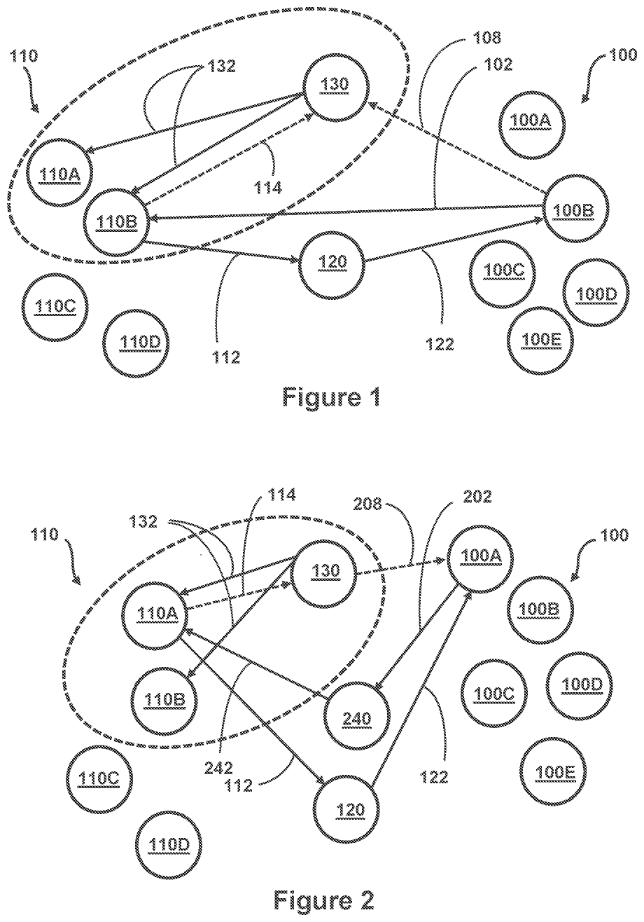

With reference to the diagram in FIG. 1, in one embodiment of the method, a plurality of customers 100 are represented by customers 100A through 100E, who would like to order food delivered to a house, office, or other location that is convenient for them to receive the ordered food. While only five customers are shown, they are representative of a whole group of potential customers 100. They can choose from any one of many food sources, represented by 110A through 110D. While only four food sources are shown, they represent all food sources 110 from which customers 100 can order food delivery. The food sources can be, by way of example without limitation, restaurants, grocery stores, food producers, farms, ranches, pharmacies, or marijuana dispensaries. Generally, food sources 110 include any business that packages its own food products, usually by hand and on a small scale, and that offers food for sale to customers 100 who want it delivered to them by delivery service 120. The traditional packaging used by food sources 110 has not been sealed or otherwise made resistant to tampering or unauthorized access by the person making the delivery. People acquainted with this market will understand that food products packaged on a large scale or products that are already packaged in sealed containers as part of the production process, do not have the same problems and risks of food tampering that exist for food sources that package products on a small scale where each order may be different and customized by each customer, and where food products delivered by traditional methods are not packaged in sealed containers and food orders are usually hand packed.

With reference still to FIG. 1, in this example, third-party validator 130 is associated with certain food sources 110A and 110B, which is indicated by the dashed bubble that encircles these food sources and third-party validator 130. Food sources 110A and 110B have entered a contractual relationship with third-party validator 130 as part of the disclosed system and method. This contractual relationship is an advantage that can be promoted to the customers as a means for ensuring that food delivered from them is secure from tampering, because of the processes and procedures that they have agreed to with third-party validator 130. The third-party validator establishes the processes and procedures and trains food sources to help with implementation. The third-party validator can also audit food sources on a regular schedule in addition to unannounced spot checks. As part of the disclosed method, third-party validator 130 can give independent validation of the processes and measures taken by food sources 110A, 110B to give the customer comfort that the food delivered from these food sources has not been tampered with. This may influence some customers to choose to order food from food sources 110A and 110B rather than food sources 110C and 110D. In the embodiment of the method illustrated in FIG. 1, line 102 indicates customer 100B making a food order with food source 110B.

An aspect that gives customers confidence in the method comes from knowing that food sources 110A and 110B will be using a computer-enabled platform for third-party validation that the food order has not been tampered with, in combination with tamper proof seal devices to prevent food containers from being opened by the person or people that are tasked with delivering the food from the food source to the customer. These people who are so tasked can be employees or contractors hired or managed by delivery service 120, employees of the food source, or someone who is hired by the food source or the customer to deliver the food, such as a taxi driver. Line 112 indicates the customer-ordered food being handed from food source 110B to delivery service 120, and line 122 indicates the food being handed from the delivery person to the customer. Customers will know that these tamper proof seal devices are supplied from third-party validator 130, as represented in FIG. 1 by reference numeral 132 that indicates lines that represent the supply of the tamper proof seal devices by third-party validator 130. For extra assurance the third-party validator may also put its brand or the name of the third-party validator on the label to further reinforce that the validation against tampering is provided by an independent third-party that will be accountable to the customer for the accuracy of the security validation. Third-party validator 130 ensures that the tamper proof seal devices are of a type and quality that will prevent any opening of the food containers from being undetected. Third-party validator 130 will know the type of food containers used by each food source that it has contracted with and will have tested the tamper proof seal devices on containers of the same type to be certain that the tamper proof seal devices cannot be removed or otherwise circumvented by someone without the access or attempted access to the food being visibly apparent. By way of example, a number of different types of tamper proof seal devices are described in relation to the figures, and the tamper proof seal devices that the third party can supply to food sources is not limited to these alone. A common characteristic is that the tamper proof seal devices cooperate with features of the food packaging to ensure that the food contained in the packaging cannot be accessed by anyone handling the package between the food source and the customer. For tamper proof seal labels that use an adhesive, the type of adhesive can be selected to work well with the material used for the food packaging, or the material for the food packaging can be designed with a coating or surface layer that will tear before the adhesive bond is broken, so that there will be visible damage to the packaging if any attempt is made to open the package. Third-party validator 130 can choose from a variety of tamper proof seal devices to choose one that is of a type, size and shape that the food source likes and that will work well with the food packaging that the food source wishes to use. The third-party validator can also provide instructions to the food source on how to apply the seal labels properly and consistently so that they will be effective in discouraging tampering. If the tamper proof seal label is of a type that employs a locking device the third-party validator ensures that it can be used with the food containers and if needed, the third-party validator can supply delivery bags that have a means of closing that is compatible with the locking device. As part of the method, the third-party validator can also provide training to the food source personnel who will be responsible for applying the tamper proof seal devices. The ability of the disclosed method to be adapted to the food containers already used by a food source is one aspect that makes this method universal. Another embodiment of the tamper proof seal device that demonstrates the universality of the security features with any type of conventional food container is the availability a locking device in combination with a zippered or latched food bag that can transport conventional food containers inside the bag and provide additional functionality to keep the food warm, if the bag is provided with thermal insulation. Furthermore, the support given by third-party validator 130 to food source 110B helps to give assurance to customer 100B by making sure that security-purposed processes and procedures designed by the third-party validator are being followed properly.

Most importantly, customers 100 will also know that each tamper proof seal device has a unique identifier that allows third-party validator 130 to track each food container, and that allows the customer to check that the unique identifier associated with the food package that is delivered, matches the unique identifier that was applied to the food package when it was sealed at food source 110B. This is important because it prevents anyone from opening the container and then putting another seal device or using another food package to give the appearance that the food has not been accessed. If the food is taken out of the original packaging, the tamper proof seal device will be damaged or destroyed and the unique identifier will not match. Once the tamper proof seal label is applied to the food container, the food container cannot be opened without verifiable evidence of access that is visible to customer 110B. For example, if the tamper proof seal device is a tamper proof label seal, technology such as cuts or perforations across the seal exist in many forms today that will perform to make it impossible to remove and re-apply a label seal without evidence of this being done. When a unique identifier is combined with a tamper proof seal device, customer 110B has an extra level of protection since it is part of the disclosed platform and method for validating to customer 110B that the food being delivered has not been tampered with. If the unique identifier on the tamper proof seal device that seals the delivered food container does not match the unique identifier that was assigned when the food was packaged, then the customer will know that the food container being delivered is the wrong food container, or that it has been opened, with someone replacing the original tamper proof seal label with another tamper proof seal device, possibly a counterfeit one, even if there is no visible damage to the replacement tamper proof seal device. The customer will also know that as part of the process agreed to by food sources 110A and 110B, the tamper proof seal devices will be applied to the food containers before the food containers are handed over to the one delivering the food container for delivery service 120. The customer knows that it is in the best interests of food sources 110A, 110B to follow the security procedures prescribed by third-party validator 130, because these food sources know that preventing tampering or anything that compromises the quality of the delivered food while being delivered helps to protect their reputation and will be good for business. If a food source does not follow the third-party validator's procedures correctly, it could be in breach of its agreement with the third-party validator and there could be penalties for breach, which could include termination of the agreement. The third-party validator has an interest in auditing its customers or otherwise checking to make sure that the food source is following the procedures properly, because if it does not, this could harm the reputation of the third-party validator, and consumers could lose confidence in the integrity of the system. Some customers may lose confidence in a food source if it was at one time using the third-party validator's process, and then stopped using it because the agreement was terminated. That is, customers 100 might be especially concerned and suspicious about the security against tampering for a food source that has had its contract terminated with third-party validator 130, and this is another reason why it is in the food sources best interests to follow the processes and procedures correctly.

Since it is known that restaurants can be very busy, especially at times during the day when people traditionally have their meals, the basic steps of the process followed by a food source are made intentionally simple and easy to follow, which facilitates compliance with the process. According to one embodiment of the method, once a food source signs an agreement with third-party validator 130, it will receive pre-printed tamper proof seal devices of a type, size and shape that are suitable to seal the types of food containers and/or packaging used by the food source. Each tamper proof seal device will have a unique identifier. With reference to FIG. 5, which illustrates the steps of the process, in step 500 a food source receives an order, and in step 510 it prepares or picks the food items ordered by the customer and puts it into one or more food containers. Once the food items are packaged, in step 520 someone employed by the food source who is trained in the process applies one or more tamper proof seal devices. Only one tamper proof seal device may be necessary, for example if only one food item is ordered, and it is packaged in one food container, or if a plurality of food containers is packaged inside a larger container such as a box or bag. In other cases, because of the way the food items are packaged, it may be necessary to apply more than one tamper proof seal device, for example if there are drinks packaged in a separate food container from food items, or if it is a large food order and the items cannot fit into one food container. The trained employee understands the principles behind the process and knows where to apply tamper proof seal devices so that all the food items will be secure from access by anyone other than the customer, without breaking the tamper proof seal device or other visible signs of access. In step 530 the unique identifiers on the tamper proof seal device(s) applied to the food container(s) are uploaded to a third-party validator's database as indicated by line 114, for example in FIG. 1. That is, line 114 indicates that in preferred embodiments the third-party validator receives the unique identifiers from the food source in real time, when each tamper proof seal device with its associated unique identifier is applied to the food container(s) and/or food packaging. Certain information associated with the order that will help with tracking can also be uploaded at the same time, such as the customer's name and address, the food source, and the items ordered. Some of the information that is uploaded can be customized to include only those that are relevant to the type of food source. To facilitate this step, the unique identifier can be machine readable, and the food source user interface that is provided by the third-party validator as part of the disclosed platform, can be programmed with the capability to enter the unique identifier into the food source computer, using, for example a scanner or a camera. The unique identifier can be, for example, without limitation, a simple code comprising letters, numbers and keyboard symbols (enabling the code to be manually entered using a mechanical or electronic keyboard), a bar code, or a QR code. It is important that step 530 is done before step 540, which is when someone at the food source hands the food container(s) over to the person who will make the delivery. This is because this means that the food is sealed and inaccessible to the food delivery person without visibly damaging the tamper proof seal label or the food container. Typically, one delivery person picks up the food container from the food source and delivers it to the customer, but this method will also work when more than one person handles the food container(s) before delivering the food to the customer. In some instances, the delivery person could pick up more than one food container and make deliveries to more than one customer. In this instance, having the food containers sealed and identified on the tamper proof seal device helps to keep the food containers from being mixed up. This is also helpful when the food delivery person is picking up food orders from more than one food source. In still other cases, a food source may have several food orders ready for pick up, and each one is picked up by a different delivery person, which can happen when different customers use different delivery service providers. This is another situation where having each order in a sealed container with a unique identifier helps to keep the orders or parts of orders from being mixed up. That is, as part of step 540, the food source employee who is responsible for handing over food orders to the delivery person(s) checks to confirm which order each delivery person is picking up, and the unique identifiers on the packaging or tamper proof seal devices can help to make sure the correct food container(s) are handed over. The process steps done by the food source are indicated by being inside a dashed-lined box. When the food container(s) are handed to the delivery person this completes the process steps in the method that are done by the food source. The method also includes step 550 in which the delivery person delivers the food container(s) to the customer. Once the customer receives the food container(s), in method step 560, the customer can inspect the packaging and tamper proof seal device to ensure that it is intact and not damaged. In this step, in preferred embodiments, because the unique identifier was uploaded by the food source in real time, the customer can access the third-party validator's database, as indicated by line 108, for example in FIG. 1, to check that the unique identifier matches what is saved in the digital database as the unique identifier that was marked in the digital database as being deployed by the food source for the delivered food order. Alternatively, the customer can contact the food source to confirm that the unique identifier on the received food container matches the unique identifier assigned by the food source. This confirms that the correct food containers have been delivered and that the tamper proof seal label was not replaced with a different one. In an alternative embodiment, in step 550 when the food source uploads the data to the third-party validator, a notification can also be sent to the customer with the unique identifier so that the customer does not need to access the third-party validator database or contact the food source to retrieve it. In one embodiment, this notification can come from the food source. In another embodiment, if the information associated with the order that is uploaded to the third-party validator includes contact information for the customer, the third-party validator could have a computer that is programmed to give an automated notification to the customer. In some embodiments, this can include the time when the food order was packaged and sealed, and an estimated delivery time. The flow chart in FIG. 5 follows the handling of the food order, and the steps taken by the food source and the delivery person but it is important to note that the method does not provide any security for the food order without the food handling and delivery process being managed by the third-party validator that creates the processes and procedures that enable the security features, the instructions and training provided by the third-party validator to the food source staff, the tamper proof seal devices and optional packaging supplied to the food source to enable the secure and sealed packaging for the food orders, the management and validation of the unique identifiers to assure customers that the food orders have remained sealed in the secure packaging when being delivered, and other processes such as ongoing audits and spot checks to give added assurance to customers with respect to the integrity of the platform.

Variations can be made to the embodiment of the method described in relation to FIG. 1 without departing from the spirit of the disclosed method concept. By way of example, without limitation, FIGS. 2 through 4 are illustrations of different embodiments of the universal method for secure food delivery. Common to all embodiments are the process steps followed by the food source and the delivery of food that has been sealed in container(s) from one of food sources 110 to one of customers 100. In the description of these alternative embodiments, the same reference numbers are used to indicate the same things and like reference numerals are used to indicate things that are alike but with some variation, as will be described in relation to each embodiment. In the description of each embodiment, things that are the same as in other embodiments and already described elsewhere may not be described in detail and the focus of the description is on what is different.

With reference to FIG. 2, this diagram shows how the method can be employed when customer 100A makes a food order through intermediary business 240. For example, intermediary business 240 can be a business that serves as a portal or gateway for customers to order food from a selection of restaurants. Examples of businesses such as this are “Foodora™”, “Skip the Dishes™”, and “Uber Eats™” and they have become a popular way for customers to order from restaurants that did not previously offer delivery services. Intermediary businesses create websites and mobile applications that consumers can use to browse food choices and to place orders. It makes it easier for consumers to try new restaurants, and to get food from popular food sources without needing to make a reservation or wait in line. These intermediary businesses can charge a fee from the customer or the food source, but either way the fees are often ultimately passed on to the consumer. Even if ordering through intermediary business 240 is more expensive than the customer ordering the food directly from the food source, it can be more convenient and less time consuming for customers, compared to customers going to the restaurant and picking up the food themselves, and the customers do not have to deal with traffic, parking and/or transportation costs. Since restaurants can benefit from the extra business, some restaurants may offer discounts on take-out food orders, which lessens the effect to the overall cost. The popularity of such intermediary businesses is a sign that consumers have embraced the value offered, and the number of businesses using this model has increased in recent years. Nevertheless, this business model could be jeopardized if consumers lose confidence in the security of the food being delivered. With consumers being able to share bad experiences to a wide audience over the internet, a viral video that shows a delivery person caught on a surveillance camera handling food in a non-hygienic manner, tampering with the food, and/or eating some of the food, could cause lasting damage to consumer confidence. Investigative reporting by conventional news outlets could also expose problems with security for food deliveries.

In the embodiment illustrated in FIG. 2, the disclosed universal method for secure food delivery can protect customers 100, food sources 110, intermediary business 240, and delivery service 120 by giving confidence to customers 100 that the food that they order will be securely delivered without being tampered with. Like line 102 in FIG. 1 indicates a food order from customer 100B to food source 110B, in the embodiment of the method shown in FIG. 2, line 202 indicates a food order from customer 100A to intermediary business 240. Intermediary business 240 then relays the food order to food source 110A, as indicated by line 242. Food source 110A receives the order as described in process step 500. Then food source 110A fulfills the order and packages it in food container(s) as described in process step 510. Food source 110A then seals the packaged food with a tamper proof seal device in accordance with process step 520. The tamper proof seal device has a unique identifier that the food source uploads to third-party validator 130 along with predetermined information associated with the order, as set out in process step 530. In this version of the method, line 208 represents a notification from third-party validator 130 to customer 100A by a preferred notification mode selected by the customer. This notification tells the customer the unique identifier, and could also be used to confirm the time when the order was fulfilled and an estimated delivery time. This notification could be by text message, telephone call, e-mail, or via a notification through the third-party validator's mobile application that the customer downloads to a smart phone, tablet or other device.

Like in the method embodiment of FIG. 1, lines 132 indicate a supply channel for third-party validator 130 to supply the tamper proof seal devices to the food sources that have contracted with third-party validator 130 to use the universal method for secure food delivery. The method of delivery is also essentially the same as it is in the embodiment of FIG. 1. After the food container(s) have been sealed with the tamper proof seal device in process step 520 and the food source uploads the data to the database as set out in process step 530, in accordance with process step 540, food source 110A hands the sealed food container(s) to a delivery person sent by food delivery service 120, who picks up the food container(s) as indicated by line 112 and makes the delivery to customer 100A as indicated by line 122.

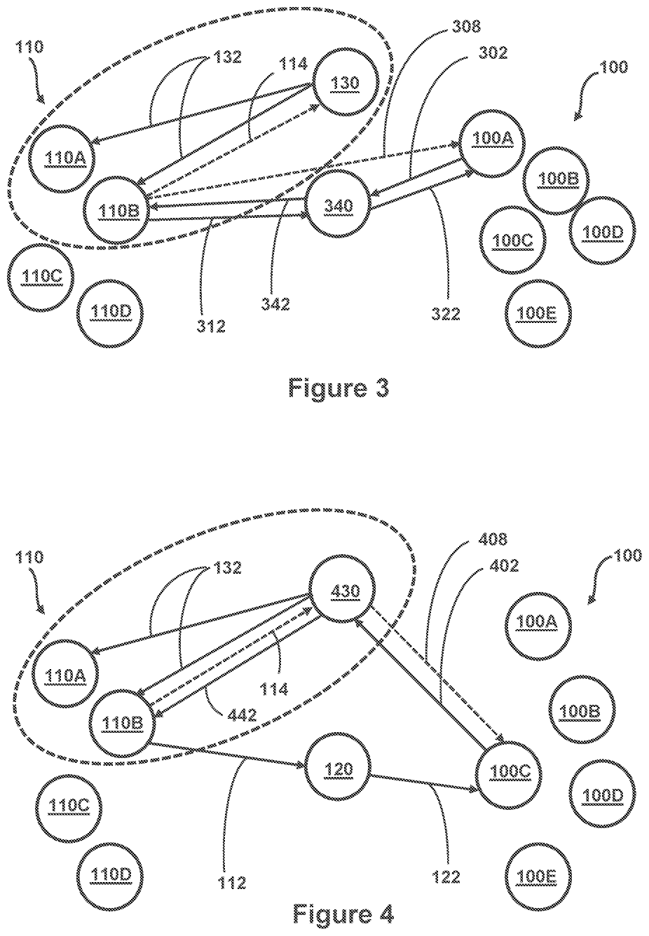

FIG. 3 is another embodiment of the method that is applied to the scenario when the delivery service and the intermediary business are combined in single value-added intermediary business 340. Like in FIG. 2, food orders are submitted directly to intermediary business 340, as indicated by line 302, and these food orders are relayed by intermediary business 340 to food source 110B as indicated by line 342. However, unlike the embodiment of FIG. 2, intermediary business 340 also handles the delivery of the food to the customers as indicated by lines 312 when a delivery person picks up the food container(s) from a food source, and 322 when the delivery person gives the food container(s) to the customer. Because the intermediary business handles both the order taking and the food delivery, an advantage of this disclosed method is that third-party validator 130 is still part of the overall method, and it may still guide some customers in their food source choices. That is, the customer still has reason to feel confident in the security of the delivered food because third-party validator 130 still gives independent oversight to make sure the procedures for securing food delivery are being followed. Again FIG. 3 shows that only some food sources are in a contractual relationship with third-party validator 130. As with the other embodiments, these food sources are supplied with tamper proof seal devices from third-party validator 130, and these food sources upload the order data, including the unique identifier to third-party validator 130. Like in the other embodiments third-party validator 130 could send a notification to the customer so that the customer is given the unique identifier so that when the food container(s) are delivered the customer can see that the correct food container is delivered and that it has not been tampered with. Alternatively, as indicated by communication line 308 shown in FIG. 3, the notification can be sent to the customer directly from the food source. Third-party validator 130 can provide food sources 110 with software, or the portal that the food sources use to upload the data, can be configured to automatically send the notifications to the customers, facilitating the use of the method by the food sources. Like in other embodiments, food source 110B is in a contractual relationship with third-party validator 130 and as required by the contract therebetween, food source 110B follows process steps 500 through 540 to give assurance to customers that the delivered food has not been tampered with. That is, a feature of the method is that once the food source staff are trained in how to follow the procedures, the extra effort that is needed is minimal, which helps with the successful adoption to the method and ongoing compliance with the procedures.

FIG. 4 is yet another embodiment of the universal method for secure food delivery. In this embodiment third-party validator 430 is also the business that takes the orders from the customers. Line 402 indicates customer 100C submitting a food order to third-party validator 430. In some respects, this embodiment is like the method of FIG. 2 with the third-party validator combined with the intermediary business. Line 442 represents the food order being relayed from third-party validator 430 to food source 110B. Food source 110B follows the procedures prescribed by third-party validator 430 as shown in process steps 500 through 540 in FIG. 5, to provide a food container with a tamper proof seal device, to delivery service 120. Even though third-party validator 430 also provides the services of an intermediary business for taking food orders from customers and relaying them to food sources, consumers still have reason to feel confident in the security around the delivered food because of the procedures agreed to and followed by the food sources, and because third-party validator 430 is still independent from food delivery service 120.

That said, within the spirit of the disclosed method, it is possible that third-party validator 430 could also operate, control or coordinate the delivery service. Once the procedures used by the food sources who adopt and agree to this method become known, and the public has confidence that the food source is following the procedures diligently, if customers are notified of the unique identifier so that they can see that the delivered food container has not been tampered with, then customers may still feel confident in the security of food delivered under the control of third-party validator 430, even though it is not independent and separate from the delivery service.

FIGS. 6 through 18 illustrate examples of tamper proof seal devices and food containers that have a tamper proof seal device applied. Some of the images are not to scale, with some of the features exaggerated or simply enlarged to better illustrate certain characteristics or shapes of features to better illustrate them and how they function.

With reference to FIG. 6, cardboard box 610 is a food container that can be used to deliver food, such as pizza. Box 610 has a lid that is attached to the bottom of the box and the lid has a creased edge to that it can be lifted to open the box. In the embodiment shown in FIG. 6, the tamper proof seal device is tamper proof seal label 620 that is shown applied to the edge of the lid that is opposite to the attached edge so that the lid cannot be lifted without breaking the seal. Like known pizza boxes, for extra security, the three free sides of the box lid have edges that can be folded perpendicular to the large surface of the lid so that before tamper proof seal label 620 is applied at the restaurant, the perpendicular edges of the lid are extended into the box towards the bottom and along the sides to make it difficult for anyone to reach inside the box without noticeably creasing or otherwise deforming or tearing box 610. Tamper proof seal label 620 bears unique identifier 630 so that the customer can confirm that the correct food container is being delivered. In this example the unique identifier is a numeric code combined with a machine-readable bar code. As with all of the illustrated embodiments, the type of box that can be used as a food container is not limited only to boxes of the style shown by box 610. Box 610 is an illustrative example for the disclosed concept, but boxes used as food containers come in many styles, which can be employed with the disclosed method by using a tamper proof seal device that prevents access to the contents of the food container without visibly damaging the tamper proof seal device or the box. For example, some boxes employ closing features that use tabs that are inserted into corresponding slots when the box is closed. The tabs are shaped to be slightly wider than the slot and/or with barbed-shaped edges so that some force is needed to insert the tabs into the slots and the box cannot be opened without pulling the tab out of the slot or cutting the tabs. The tabs can be shaped with a narrower base, with perforations or other means for providing a weak point that prevents the tabs from being removed from the slots without visible signs of tearing or other damage to the tab base or barbed edge, or to the slot, to prevent unauthorized access to the contents from being undetected. In another embodiment (not illustrated), tamper proof seal devices can be integrated with food container boxes by printing a unique identifier on each food container box. With sealable boxes, such as those described by US Patent Application Publication No. 2017/0362008A1, none of the boxes had unique identifiers and this did not allow third-party verification and no guarantee that the contents had been tampered with and then transferred to a new box and sealed therein. When each food container box has a unique identifier printed on it, the tamper proof seal label is integrated with the food container box, and the food container box can be manufactured with an adhesive strip to seal the box, or it can be sealed with a plain seal that employs a strong adhesive and tamper proof features like cuts, but breaking of the seal or breaking the food container box will be evident to the customer receiving the food, and the food container box cannot be replaced with a new food container box because of the unique identifier.

FIG. 7 depicts a paper or plastic bag 710 into which a plurality of smaller food containers can be deposited. Because the top of the bag is folded over or rolled down, bag 710 cannot be opened without breaking tamper proof seal label 720. In this example, unique identifier 730 is an alphanumeric code that is machine readable. In some embodiments, when the food being delivered is hot, bag 710 is made from a breathable material to allow the release of water vapor, to prevent the food from getting soggy. For example, the bag can be made from paper, cloth, plastic, with or without impermeable coatings (to contain spilled liquids or grease), and can include perforations or mesh sections to allow vapor to escape. In another embodiment, the bag can be made with an adhesive strip that is employed by peeling away a non-stick covering piece for sealing the bag, similar to the self-sealing bags used by some courier companies. This type of bag provides extra security against tampering, and in this embodiment the tamper proof seal label can be integrated with the bag by printing the unique identifier on each bag. In another embodiment (not illustrated), tamper proof seal labels can be integrated with sealable plastic bags. This embodiment is similar to the illustrated embodiment in FIG. 7, except that a unique identifier is printed or otherwise marked on each plastic bag and the bags are manufactured with a sealing mechanism, such as a strong adhesive strip that is employed to seal the plastic bag after the food items have been deposited inside. Alternatively, after the food is deposited into the bag a melt seal could be applied to seal the bag. Sealable tamper evident plastic bags are already known products and are used for example by courier companies for delivering documents and packages. By printing the unique identifier directly onto tamper evident sealable bags, this saves the step of applying a separate tamper proof seal label and the features of a tamper proof seal label are integrated with the bag. By checking that the unique identifier matches what has been communicated to the customer by a third-party validator, the customer can be assured that the contents were not tampered with and then transferred to another bag. Any tampering of the bag will be observed if there are any holes in the bag or if the seal has been broken.

FIG. 8 depicts “clam shell” style food container 810. These types of food containers can be made from various materials, including plastic or expanded polystyrene foam (e.g. Styrofoam™) or biodegradable substitutes. Once tamper proof seal label 820 has been applied, this food container cannot be opened without breaking the seal or visibly deforming the container. Like in the other embodiments, tamper proof seal label 820 bears unique identifier 830 that the customer can use to verify that the correct food container is being delivered, and that the same seal that was applied at the food source is still on the food container when delivered. In another embodiment (not illustrated), clam shell food containers can be manufactured with unique identifiers printed or otherwise marked on each container. Like in other described embodiments, this type of packaging can also be manufactured with a strong adhesive strip or another mechanism for sealing the container such that it cannot be opened without evidence of tampering and the unique identifier gives assurance to customers because it can be verified by a third-party validator as the same box that the food sourced used to package the food items.

In the embodiments shown in FIGS. 6 through 8, the tamper proof seal label is in the form of a sheet label medium with an adhesive backing. The material for the sheet label can be paper or plastic, and one or more features or material characteristics can be employed, so that once applied to the food container or packaging, the tamper proof seal label cannot be removed without visual evidence to show that the food container has been opened. For example, a strong adhesive can be used so that the tamper proof seal label cannot be removed without tearing or stretching and deforming the seal label. The tamper proof seal label can also include cuts or perforations that cause the sheet label to be destroyed when removed to open the food container.

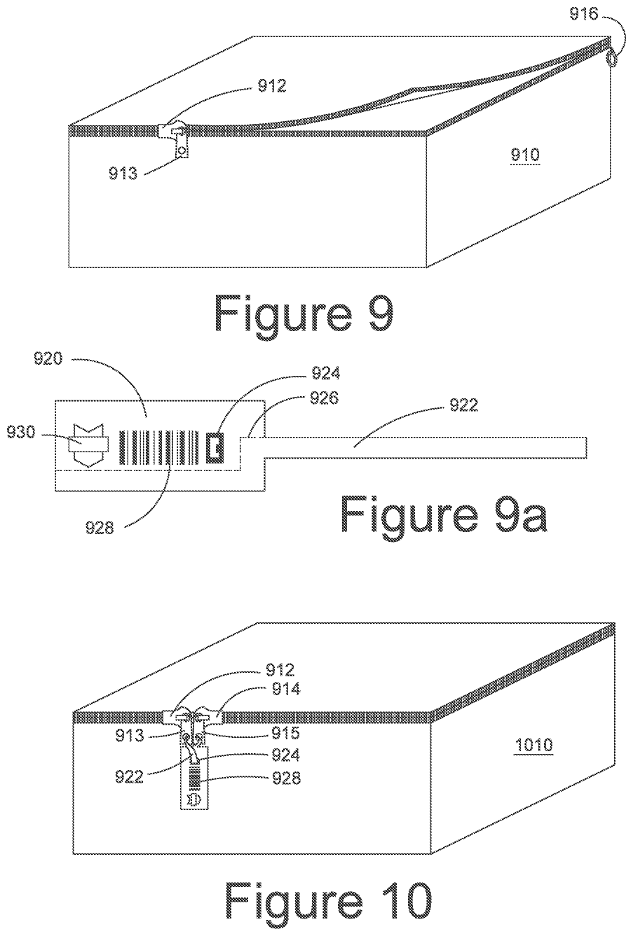

FIGS. 9, 9a and 10 illustrate an embodiment of the tamper proof seal device that comprises self-locking loop 922 that prevents food container 910 from being opened without breaking the tamper proof seal device, where tag 920, marked with a unique identifier is integrated with self-locking loop 922. In the illustrated embodiment, food container 910 is a zippered bag, shown partially open in FIG. 9. Food container 910 can be a thermally insulated and re-usable bag. By way of example, food container 910 can be made from a multi-layered material with a textile outer layer, and thermally insulating middle layer and a liquid impermeable inner layer. In other embodiments, the food container can be made from a hard plastic, similar to hard shell plastic luggage that is sealed with a zipper, and with some embodiments the hard-plastic shell can be double-walled with an air gap for thermal insulation. Food container 910 could also be made from a composite or from metal. In the example shown in FIG. 9, food container 910 has a single zipper slider 912 that provides a means for cooperating with a locking device and fixed loop 916 to seal it.

With reference to FIG. 9a, integrated tag 920 and stem 922, which is insertable into ratcheting receiver 924 to form a self-locking loop are made from a single molded piece, that can be made from nylon or other plastics with similar physical properties. The material for this form of tamper proof seal device can be a recycled material and/or a biodegradable material. The material can be in different colors and the tags can be in different shapes in order to be distinctive for the third-party validator or for different food sources or food types, or to be collectable as distinctive and/or limited-edition shapes. In this embodiment, ratcheting receiver 924 is integrated with tag 920. Ratcheting receiver 924 provides an opening into which the free end of stem 922 is inserted to form a closed loop. The opening in ratcheting receiver 924 is shaped to cooperate with the shape of stem 922 so that there is a ratchet effect that prevents stem 922 from being pulled out of ratcheting receiver 924, so that stem 922 is locked into ratcheting receiver 924 once inserted. Stem 922 can be designed to break before it can be pulled by force out of ratcheting receiver 924, leaving the tamper proof seal label visibly broken if anyone other than the customer tries to open the closed loop. Before the free end of stem 922 is inserted into ratcheting receiver 924, packaged food is deposited into food container 910 and zipper slider 912 is drawn to the end of the zipper near fixed loop 916 to close food container 910. Then the food packager threads the free end of stem 922 through the openings in pull tab 913 of slider 912 and fixed loop 916 and finally into ratcheting receiver 924 so that slider 912 is held next to fixed loop 916 to seal food container 910. As shown in FIG. 9a, a unique identifier such as bar code 928 can be printed on integrated tag 920. For added customer confidence, the name of the third-party validator can also be printed on integrated tag 920, or, as depicted in FIG. 9a, a distinctive logo 930, that is preferably a registered trademark of the third-party validator can be displayed so that the consumer knows that the contents of the received food container have been packaged according to the processes established by the third-party validator, which means that the food container was sealed before it was handed over to the person making the delivery.

In the embodiment shown in FIG. 10, food container 1010 has double separating zipper sliders 912 and 914, and when they are brought together as shown in FIG. 10, food container 1010 is closed. By inserting stem 922 through the openings in pulls tabs 913 and 915 of respective zipper sliders 912 and 914, and then into ratcheting receiver 924. Some zipper sliders have integrated rings that are offset to overlap and cooperate with each other when the double separating sliders are brought together, as with some luggage zipper sliders, and these can be employed as a more rugged alternative to using the holes provided in the pull tabs. When sealed food container 1010 is delivered to the customer, the customer can verify that unique identifier 928 matches the unique identifier that was sent from the third-party validator or the food source. Then the customer can cut stem 922, allowing zipper slides 912 and 914 to separate so that food container 910 can be opened. This type of tamper proof seal device can optionally include pre-molded tear-line 926 (shown in FIG. 9a), which is a feature designed to facilitate tearing integrated tag 920 from stem 922 to make it easier for the customer to break the locking device to open sealed food container 910 without using a knife or scissors to cut stem 922. Pre-molded tear-line 926 can be formed, for example, by perforations, slits, or a groove that makes label tag 920 thinner along tear-line 926.

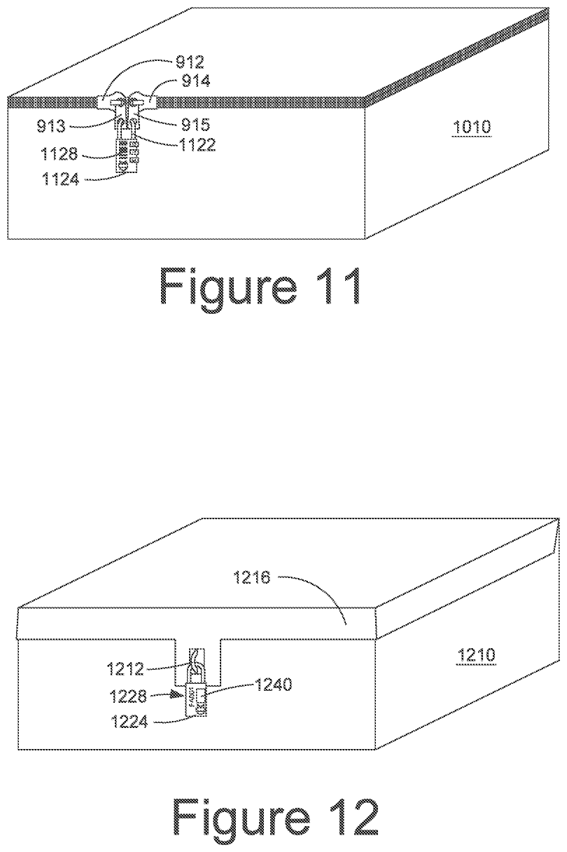

FIG. 11 shows food container 1010 with a different type of tamper proof seal device. In this embodiment, the locking function is provided by padlock 1124 and the unique identifier is bar code 1128, which is displayed on the body of padlock 1124. Padlock 1124 is opened to insert loop 1122 through holes provided in pull tabs 913 and 915 so that when loop 1122 is locked in the body of padlock 1124 food container 1010 cannot be opened until padlock 1124 is opened by the customer. The customer can open padlock 1124 because instructions for opening padlock 1124 are provided to the customer from the third-party validator or directly from the food source. The padlock can use any type of mechanism for locking and unlocking. For example, the padlock can have an electronic mechanism that is operated by inputting a key code by an electronic signal using RFID, infrared, audio, or biometric inputs. Alternatively, the padlock can have a mechanical mechanism as depicted in FIG. 11, with a means for inputting a numeric combination to open and close the padlock. According to the method, staff at the food source are trained to seal food container 1010 with padlock 1124 before the food container is picked up by the person making the delivery, so that the food inside food container 1010 cannot be tampered with while being delivered to the customer. In preferred embodiments the code or combination for opening the padlock can be changed each time the padlock is deployed by a staff member at the food source so that the customer is confident that no one in the delivery chain can open the padlock while the food container is in transit. The staff member can upload the combination to the third-party validator, who transmits it to the customer when the customer reports the unique identifier associated with the packaged food when it is delivered, or the staff member can transmit the code or combination directly to the customer along with a hyperlink for accessing the third-party validator and/or tracking information.

FIG. 12 shows that any type of food container than is capable of being sealed can be employed with the disclosed method. Instead of zippers, an arrangement with hasp latch 1212 that is shown in a locked arrangement with padlock 1224, but other types of locking devices such as the tamper proof self-locking loop shown in FIG. 9a could be substituted to seal food container 1210. Compared to zippered food containers, the lid and walls of food container 1210 are preferably more rigid, and if made from a fabric bag, the panels of the bag can incorporate panel inserts made from corrugated cardboard, expanded polystyrene foam, hard plastic or metal, for example, so that the corners of the lid cannot be lifted from the walls when food container 1210 is sealed without causing visible damage to the container or removing padlock 1124. In other embodiments, food container 1210 can be made without using a fabric bag, with the container made from molded hard plastics, expanded polystyrene foam, cardboard with a liquid repellant coating, or other materials with suitable structural integrity to form a food container than can be closed with a hasp latch and that prevents access to the container interior when closed. In some embodiments, food container 1210 is designed to keep the contents cool or warm with thermal insulation and is re-usable. In some embodiments, the lid can also include overlapping vertical edge 1216 to provide a better seal, to provide more rigidity to the lid, and as an additional feature to prevent access to the contents. Padlock 1224 depicts an embodiment of a padlock that uses an electronic mechanism, and panel 1240 represents an electronic input receiver, such as a biometric scanner, or a receiver for an electronic signal code that can be transmitted from a smart phone. By way of example, padlock 1224 shows that the unique identifier can take forms other than a bar code, and in this embodiment, unique identifier 1228 is an alpha numeric code that the customer can easily read without the use of a bar code scanner, to facilitate verification that the correct food container is being delivered.

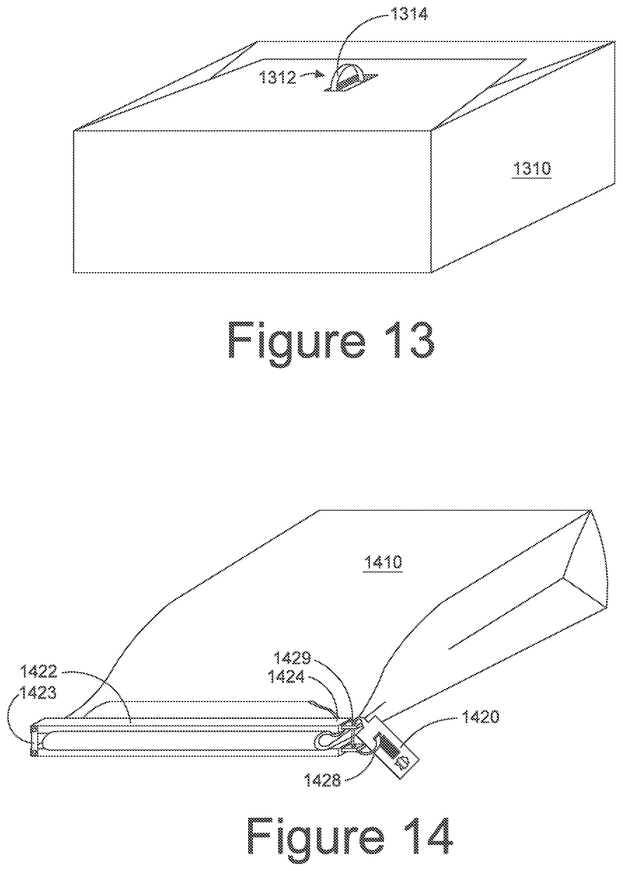

In FIG. 13, like food container 1210, food container 1310 uses a hasp latch, but in this arrangement hasp latch 1312 is located where loop 1314 is provided on one lid section that is folded flat first, so that it is the lowest lid section, and then the other three lid sections are folded down next. Each of the other three lid sections has an opening through which loop 1314 can extend so that when all four lid sections are folded down, loop 1314 protrudes from the lid surface to receive a tamper proof seal device. In another alternative arrangement (not shown), the overlapping lid arrangement can be used without the hasp latch, and instead a sheet-type tamper proof seal label with adhesive backing can be applied to the overlapping lid sections to prevent access to the container contents.

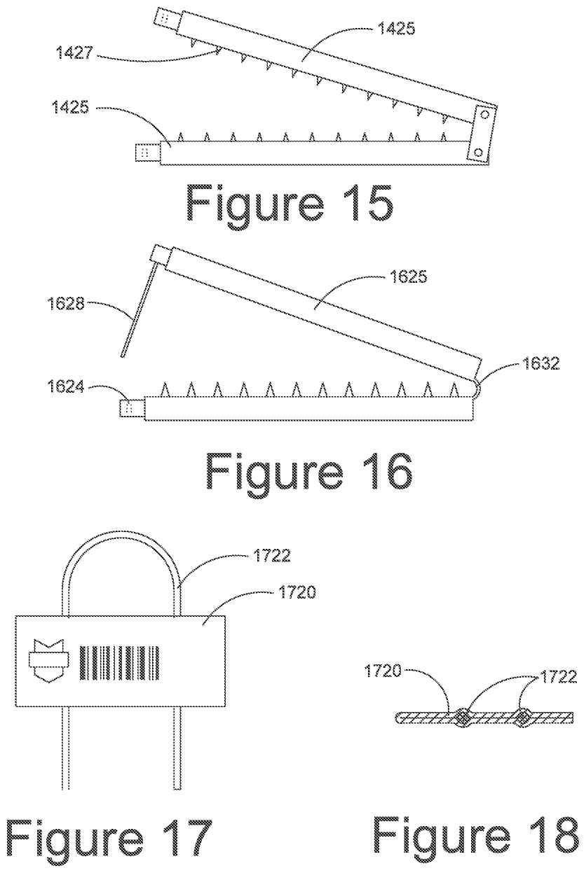

Food container 1410, shown in FIG. 14, can be similar to bag 710 shown in FIG. 7, but with a different type of tamper proof seal device. In FIG. 14, food container 1410 is sealed with clamping locking device 1422, which can be made from a stiff plastic or a composite or laminated material that has enough stiffness so that it cannot be pried open. In the example shown in FIG. 14, clamping locking device 1422 comprises hinged end 1423 opposite to locking end 1424. FIG. 15 shows an embodiment of clamping locking device 1422 in an open position, showing that bars 1425 and 1426 can be formed with teeth 1427 for better gripping of the clamped food container bag, and in some embodiments, at least some of the teeth can be designed to pierce the clamped bag so that the bag cannot be pulled from the closed clamp without tearing the bag. In the depicted embodiments, to better illustrate the concept, the teeth are shown as protruding from bars 1425 and 1426, but in preferred embodiments the teeth can be provided in a recessed area within a channel-shaped bar so that the teeth will not cut users or their clothing. In such an embodiment, the teeth are engaged with the food container bag when the clamp is closed and the bag is pushed into the channel by the clamping action. In yet another embodiment, the teeth can be recessed and then pushed out from the clamping face of the bars when the clamp is closed. Locking end 1424 has closed loops for receiving a lock, such as a padlock or the tamper proof seal label as shown in FIG. 14. The illustrated tamper proof seal label is like the one shown in FIG. 9, and comprises tag 1420 integrated with self-locking loop 1428. That is, once the food source employee has placed the ordered food into food container 1410, the open end of the bag is closed. The bag can be rolled up if the food items do not take up all of the space within food container 1410. Then clamping locking device 1422 is closed over the rolled end of food container 1410 to seal it by clamping it therebetween, and clamping locking device 1422 is then held in the closed position by inserting stem 1428 of a self-locking loop through clamp loops 1429 and then pulled tight through the ratcheting receiver to hold clamping locking device 1422 in the closed position. FIG. 16 shows another embodiment of a clamping locking device that replaces clamp loops 1429 with an integrated self-locking device. To close clamping locking device 1622, stem 1628 is inserted into ratcheting receiver 1624, which has ratcheting features so that when stem 1628 is fully inserted into receiver 1624 it cannot be withdrawn. In this embodiment the unique identifier can be printed onto a visible location on bar 1625, and once the customer verifies that the unique identifier matches what has been sent from the food source or the independent validator, then the customer can open the food container by cutting the stem or tearing open the bag. In this embodiment clamping locking device 1622 is made from a material, such as plastic, that can be formed with integrated hinge 1632 that is a thin and repeatably bendable.

FIGS. 17 and 18 illustrate yet another embodiment the tamper proof seal label that can be used instead of a padlock or self-locking loop. What is shown in FIG. 17 is a front view of a tamper proof seal label that comprises adhesive-backed sheet label 1720 folded over cord 1722. FIG. 18 shows a section view of cord 1722 sandwiched between folded sheet label 1720. Sheet label 1720 displays the unique identifier and a strong adhesive prevents cord 1722 from slipping from between the two sides of folded sheet label 1720. Cord 1722 can be made from string, twisted paper, wire, or a plastic cord. Some users may prefer a biodegradable material like twisted paper because it is easy to tear so it is easy for the customer to open the food container and to see if the loop has been damaged if anyone has tried to access or tamper with the food inside the container.

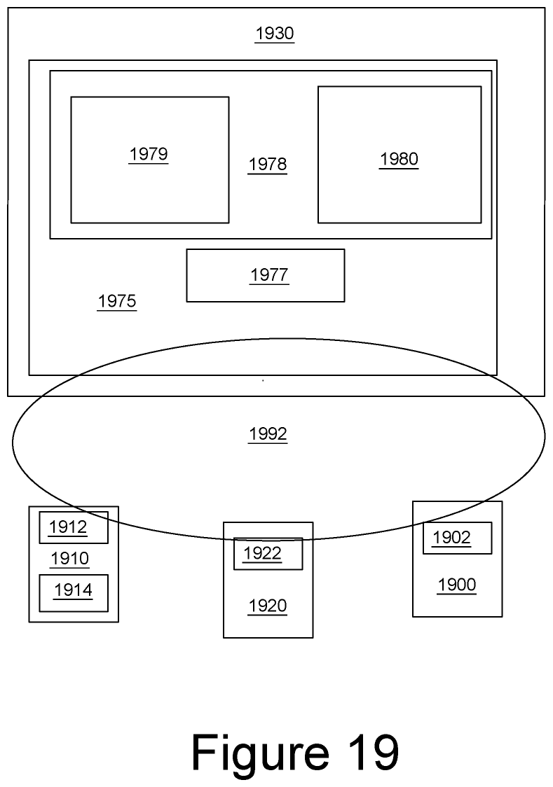

An illustrative example of the disclosed food delivery platform and system is shown in FIG. 19. The platform comprises both hardware and software, for the computer-implementation of the system for third-party validation of a secure delivery of a food order from a food source to a customer. The hub of the platform shown in FIG. 19 is one or more servers 1975 that host a website that acts as a portal for access to the system operated by third-party validator 1930. One or more servers 1975 comprise one or more processors 1977, memory 1978 on which is stored set of instructions 1979 and digital database 1980. System users include a plurality of food sources, represented in FIG. 19 by food source 1910, a plurality of customers, represented by customer 1900, and in some embodiments, the delivery people or delivery services can also be connected, with these people and delivery services being a plurality of entities represented in FIG. 19 by driver 1920. In some embodiments, for a single food order, driver 1920 could be representative of one of a few drivers in a chain of people that handles the food order to deliver it to customer 1900. For example, a company that manages the delivery service could use a truck to collect all of the orders for a predetermined territory and bring them to a distribution hub from which the food orders are handed off to drivers of smaller cars or delivery people on bicycles or on foot to shorten the overall delivery time within smaller sub-areas. There can be different variations of the disclosed platform, but with each platform, third-party validator 1930 is responsible for the processes and systems that are used by the method to assure customers that food orders validated by third-party validator 1930 are secure from tampering from the time it is released from the food source to the time when it is delivered. Accordingly, third-party validator 1930 provides the user interface programs that are used by the users, which in some embodiments can be food source 1910 and drivers 1920, in another embodiment this can be food source 1910 and customer 1900, and in yet another embodiment it can be all of them, namely food source 1910, driver 1920 and customer 1900, The method steps for enabling each of these embodiments are described in this disclosure. In preferred applications of each embodiment, all scans, data entries, notifications and other communications within the platform, between the user interfaces and the third-party validator, are all date and time stamped, and a location stamp can also be enabled for when the package is out for delivery or being delivered. In all embodiments, because the process defined by the third-party validator for packaging and sealing of the food at the food source is an essential element of the method, in every embodiment of the platform there is a user interface for food source 1910.

Food source 1910 has an inventory of supplies 1914 that can comprise secure packaging and tamper proof locking devices with unique identifiers permanently associated therewith. The unique identifiers can be marked directly on the tamper proof locking devices, or permanently marked on or molded into tabs attached thereto, or printed on tamper proof seal labels applied to the tamper proof locking device, or integrated with a tamper proof seal label. By way of example, the tamper proof locking device can comprise self-locking loops, locking clamps, padlocks, an adhesive strip on a plastic or paper bags for sealing it, other tamper proof locking devices described elsewhere in this disclosure, or equivalent locking devices used to seal food packaging against unauthorized opening. Once the food source packages a food order and follows procedures established by the third-party validator to seal the food order in the secure packaging with the tamper proof locking device, a unique identifier that was assigned to the food source by the third-party validator is then associated with the packaged food. That is, according to the procedures established by third-party validator 1930, all of the unique identifiers in the inventory of food source 1910 have already been associated with food source 1910 in digital database 1980. According to the procedures established by third-party validator 1930, all of the unique identifiers that have been previously used by food source 1910 have been marked “used” in the digital database so that the same unique identifier cannot be used again, unless it is re-issued by the third-party validator. Initially, all of the unique identifiers that the third-party validator assigns to food source 1910 are saved in digital database 1980 and marked as “available” for use by food source 1910. If another food source uploads a unique identifier that is assigned to food source 1910 in digital database 1980 or that is a unique identifier that is marked as “used”, this will trigger an automatic alert to instruct the other food source to use another tamper proof sealing device or another package with a different unique identifier.

For each food order packaged by food source 1910, food source 1910 uses food source computer 1912, which has a food source user interface for uploading the unique identifier to the server operated by third-party validator 1930. The program for the food source user interface is provided by the third-party validator and is part of the disclosed platform. The food source user interface and server 1975 can communicate over a communications network, such as the oval in FIG. 19 that represents internet 1992. When third-party validator server 1975 receives the unique identifier, processor 1977 follows set of instructions 1979 to automatically reference digital database 1980 to verify that the unique identifier is assigned to food source 1910, and that the unique identifier has not been previously deployed, marked as used, or otherwise invalid. Third-party validator 1930 immediately alerts food source 1910 if the unique identifier is invalid, and if the unique identifier is confirmed to be valid the processor confirms that to food source 1910 and marks the unique identifier as “deployed” in digital database 1980. A unique identifier that has been marked as deployed signals to processor 1977 that this unique identifier cannot be approved for use with any other food order.

If processor 1977 determines that a unique identifier is invalid, there can be a number of reasons for this. For example, a food source can report a damaged or spoiled and un-usable tamper proof seal device associated with a unique identifier. This can be common for tamper proof seal devices that are adhesive labels because the tamper proof features of labels can cause it to tear if not used carefully. In other cases, an audit of a food source's inventory could find that unique identifiers assigned to the food source are missing. The missing unique identifiers could be lost or stolen or simply misplaced, and according to the procedures established by third-party validator 1930, to protect the integrity of the platform, the food source is required to report all missing and unaccounted for unique identifiers to third-party validator 1930 so that the status for these unique identifiers is marked as invalid in digital database 1980. An invalid status for a unique identifier can be revoked if a food source later reports that it has found the unique identifiers that were previously reported lost, and then the food source can return the found unique identifiers to service once the third-party validator confirms that the invalid status is removed from the digital database. The food source user interface can include features for helping with inventory records. A scanner or camera that is used to enter unique identifiers, or a similar device can also be used for taking inventory to periodically confirm that the food source's inventory of tamper proof sealing devices and associated unique identifiers is up to date and that nothing is missing. At the same time, the food source can ensure that any damaged tamper proof seal devices are reported so that the third-party validator can mark the status of the associated unique identifiers as invalid and out of service. Tamper proof seal devices packaged in sealed packaging can have a bulk code so that a series of unique identifiers can be inventoried without entering each unique identifier individually. Access to the inventory function in the food source user interface can be restricted to authorized personnel, for example, at the manager level.

Still with reference to FIG. 19, and the illustrated platform for secure delivery of food, when customer 1900 receives the food order, customer 1900 can inspect the packaging to be sure that it has not been opened by checking for holes in the packaging or visible damage to the tamper proof sealing device. Customer 1900 uses customer computer 1902 to communicate with third-party validator server 1975 through a communications network such as internet 1992, using a customer interface program provided by the third-party validator. The customer interface program is part of the disclosed platform and it can be obtained from the third-party validator's website or from an “app store” for free or for a nominal fee, as determined by the third-party validator. The third-party validator can offer different types of customer interface programs, such as mobile apps for customers that wish to load it onto a smart phone or tablet, or a desktop program for customers that wish to load it onto a desktop computer. If the customer interface program is a mobile app, it can be programmed to give the customer the option to use the camera of the mobile device to scan the unique identifier, or alternatively, to enter the unique identifier manually. The mobile app can also provide a means for the customer to take pictures of the packaging that can be uploaded to server 1975 so that the customer can immediately report any damage to the packaging or the tamper proof sealing device that could indicate tampering. If the packaging looks intact, customer 1900 can use the customer interface program to scan or manually enter the unique identifier, which is then automatically shared with third-party validator 1930. Upon receiving the unique identifier, from customer 1900, processor 1977 checks that it matches with the unique identifier uploaded by the food source, which was marked “deployed”. Processor 1977, as directed by set of instructions 1979, automatically checks digital database 1980 and compares the unique identifier reported by customer 1900 with the unique identifier uploaded by food source 1910 and marked as deployed for the received food order. If there is a match, processor 1977 confirms to customer 1900 that the security of the food order is validated and then the processor makes the unique identifier as “used” in digital database 1980. In preferred embodiments, the processor can be instructed to also record performance metrics including the time when the food order was delivered, and any positive or negative comments reported by customers. If there is no match, processor 1977 communicates to customer 1900 that the security of the food order cannot be validated because the unique identifiers do not match. Processor 1977 then marks both of the unique identifiers as used in digital database 1980 and also stores in digital database 1980 a record of the food order, the two different unique identifiers associated with that order and the time that the delivery was reported by the customer and the time the customer was notified that the security of the delivery could not be validated. In preferred embodiments, set of instructions 1979 also direct processor 1977 to communicate a copy of the record to food source 1910. If the customer uploads any picture of damaged food packaging or damaged tamper proof seal devices, these pictures are also saved in digital database 1980 and shared with the food source.

FIG. 19 further shows that in a preferred embodiment of the platform driver 1920 is also connected to third-party validator server 1975 by means of driver computer 1922, using a driver interface program provided by third-party validator 1930. The driver interface program can be part of the platform and can be obtained from the third-party validator's website or from an app store for free, for a fixed fee, or for an ongoing license fee, as determined by third-party validator 1930 and the chosen business model. The third-party maintains control over the driver app, so that it can be revoked or blocked for drivers if they become the subject of verified complaints or who are proved to breach conditions of use established by third-party validator 1930. These conditions of use can include performance metrics that drivers need to meet or exceed to continue to have use of the app. The occurrence of a delivery where the unique identifier on the delivered package does not match the unique identifier uploaded by the food source is a serious matter, requiring a reasonable explanation, since without any explanation, the assumption would be that someone tampered with the packaging. By investigating unique identifiers that do not match, third-party validator 1930 can discover other causes, which could result in more problems if not corrected. For example, third-party validator 1930, could discover that food source 1910 has a faulty scanner, or that employees at another food source have not been trained properly. Since third-party validator 1930 keeps a record of all deliveries that could not be validated, an examination of the record can reveal if the problem is with a driver or with a particular food source. That is, if the records in digital database 1980 show that particular driver has a record of too many food orders that were not validated, or reveal that a particular driver has a record of taking too long to complete the deliveries, or if a driver receives too many complaints from customers, then the problem can be isolated to that driver and before a negative pattern develops and before the reputation of the food delivery system is damaged, third-party validator 1930 can give feedback to a driver and invite the driver to provide an explanation and give a warning that a pattern of unsatisfactory performance will result in the driver being blocked from using the app. If the unsatisfactory performance continues, the third-party validator can block such a driver from using the app. While blocking a driver can be unfortunate, this will result in better service levels for the customers and will give confidence to all users of the platform that the reputation of the food sources, the drivers and the third-party validator will be protected. In ideal circumstances a more positive outcome is achieved if the feedback given to the driver from the third-party validator helps the driver to improve his or her performance and improve the overall service levels. The driver user interface is not just to collect data on the driver performance metrics. There are also advantages for drivers to use a driver user interface that affords useful functionality that is helpful for drivers. For example, in situations where customer 1900 is not home to receive the food order, the driver app can be programmed to receive inputs from the driver that can be uploaded to the server as an alternative to the customer reporting the unique identifier. The driver user interface can be used to take and upload pictures of the food order with the packaging integrity intact, and to photograph or otherwise scan or manually input the unique identifier, time-stamped together with GPS location data. For extra confirmation driver 1920 can also take pictures of the delivery location (the building and address) and also upload this to the third-party validator's server. This way driver 1920 can complete the delivery with proof that the food order in the original packaging, was delivered to the correct location. The third-party validator can establish procedures for how this situation is to be handled, so that this alternative is not abused by drivers who might otherwise try to take a short cut by not even ringing the doorbell. For example, driver 1920 may still be required to wait and not leave the customer address until released by the third-party validator. For example, processor 1977 can determine from instructions 1979 how to handle this situation. Processor 1977 will still compare the unique identifier uploaded by driver 1920 to the unique identifier uploaded by the food source. The food source interface can include features for the food source to indicate special delivery instructions from customer 1900, such as authorization to leave a food order at the back door, instructions for accessing the lobby of a condominium or apartment building, or instruction for accessing a gated community. These special instructions are collected for the benefit of driver 1920 in circumstances such as when the customer is not present to accept delivery, and processor 1977 can be instructed to convey this information to driver 1920 through a driver app loaded onto driver computer 1922. In cases where a customer lives in an apartment building with secure access, the customer can give instructions to be contacted when the food arrives so that the customer can go to the secure door and receive the ordered food. In this case the driver may be informed through the driver user interface that the customer has been notified and is coming to meet the driver, and instructing the driver to wait until the customer arrives. Another optional feature in preferred embodiments of the customer user interface there can be means for the customer to create a customer profile that is accessible to the third-party validator, where the customer can indicate preferences or default instructions for specific events, and contact information so that the third-party validator can pro-actively contact the customer to resolve any issues to facilitate delivery. The customer profiled can be stored in digital database 1980. The customer profile can also give the customer the option to authorize default actions that can be taken to complete a delivery if a driver is at the customers address and the customer cannot be reached. The role of the third-party validator in the described platform can be an advantage if a customer does not to share their contact information with driver 1920. Instead, when driver 1920 reports that he or she is at the delivery address and cannot hand the food order into the customer's hands, processor 1977 can be instructed to automatically send a text notification or an automated phone call to customer 1900 to confirm that the food order is at the designated address. Some customers can be concerned about the privacy of their personal information and for this reason they may not wish to create a permanent profile. The platform can include the option for customers to indicate that they wish to share their contact information only for the purpose of completing the food order that one time, and if this is indicated, processor 1977 can be programmed to delete the customer contact information after the food order delivery process is completed. When customers authorize the food source to share customer contact information within the platform, they can choose restrictions on with whom this information is shared.

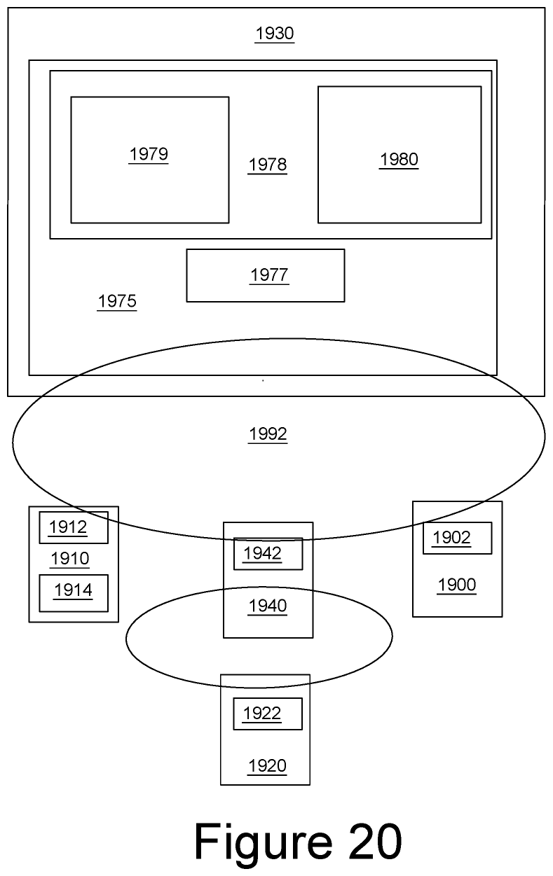

With reference to FIG. 20, only differences between the platform shown in FIG. 19 and the platform shown in FIG. 20 are described in detail and like-referenced elements in the platform shown in FIG. 20 function in substantially the same manner as in FIG. 19. In the platform illustrated in FIG. 20 intermediary business 1940 interfaces with server 1975 by means of computer 1942 that has an intermediary user interface provided by third-party validator 1930. Intermediary businesses exist today, as service providers like Skip the Dishes™, Uber Eats™, and Foodora™. Customers can order food from restaurants using such services. As shown in FIG. 20, the disclosed platform can be used with these existing companies and an advantage of this is that intermediary business 1940 facilitates deliveries by enabling a pool of drivers who can make the deliveries. The larger oval that represents internet 1992, the smaller oval also represents the internet, in this instance the communications network between intermediary business 1940 and drivers 1920. Drivers 1920 can still use a mobile phone or other computer device equipped with the driver app to help complete deliveries and to help with tracking the location of food orders, but intermediary businesses 1940 can still function as they do now, but with additional capabilities to ensure the secure delivery of food orders and to assist with the completion of the delivery of those food orders. Intermediary business 1940 has intermediary computer 1942 that has an intermediary user interface provided by third-party validator 1930. Third-party validator can include features in the user interfaces that help different users to function more efficiently. For example, the intermediary user interface can allow intermediary 1940 to access GPS data and other performance metric data collected from drivers 1920 for food orders managed by intermediary 1940, and intermediary 1940 can help to use this data to track performance and to keep food deliveries secure. Since drivers 1920 work for intermediary 1940 either as employees or independent contractors, intermediary 1940 can have more influence over their performance and could have more manpower nearby for supervising drivers 1920. The customer user interface can be designed to enable the customer to give feedback to intermediary business 1940, which can be used constructively to improve customer satisfaction. In all embodiments of the platform, food source 1910 can use the food source user interface to communicate to others within the platform, with information that is pertinent to each party, such as the time the food order was submitted, the time the food order was picked up for delivery, the contents of the food order, the unique identifier, and the customer name and contact information (to the extent that the food source has been authorized by the customer to share such information).

The disclosed computer-enabled platform and method for secure food delivery from a food source that sells food to a customer, uses a computer application with a plurality of user interfaces. In an illustrative example, the food source is a restaurant. The first user interface, referred to in this example as the “Restaurant App” can be a desktop or mobile application accessible to a person at the food source (the “Restaurant User”) by means of a desktop computer, a tablet, or a smart phone. When the Restaurant User receives an order from a customer, the Restaurant User opens the home page of the Restaurant App and clicks or taps on a button for NEW ORDERS, which opens a page where the Restaurant User can enter information such as the customer name, the customer address, the order, the payment method, and the delivery company. If the customer has ordered from the restaurant before, the Restaurant App can be programmed to save customer information so that when a stored name or phone number is entered, the Restaurant User can then verify and accept customer information automatically populated from the saved customer information. Next, the Restaurant User clicks or taps on a button to NOTIFY DRIVERS to notify delivery drivers that there is a new order that needs to be picked up. This order is then given a “pending” status and stored in a list of orders PENDING ACCEPTANCE. When a driver accepts the order, this means that the driver agrees to pick up the order and deliver it to the customer, and then the order status is changed and automatically removed from the list of orders PENDING ACCEPTANCE and added to a list of orders ACCEPTED BY DRIVER. When the food order is packaged and ready for pick up, the restaurant staff puts the food into a delivery container and secures it with a tamper proof seal label. Then the Restaurant User opens the Restaurant App and clicks or taps a button for entering the unique identifier on the tamper proof seal label. The unique identifier can be entered, for example, without limitation, using an optical scanner or camera, to enter a bar code, QR code, alpha numeric code. To ensure that each step of the process is completed for every order, the Restaurant App can include flags or other indicators to show that a process step has not been completed yet, and check marks or other notifications to indicate when each process step is done. In some embodiments the Restaurant App can prevent an order from changing status until all of the required process steps are completed. In some situations, when the food order is being packaged and sealed, the tamper proof seal device can be damaged. This can happen, for example if the Restaurant User forgets to include an item and has to break the seal. Then a new tamper proof seal device can be applied, but then the broken or spoiled tamper proof seal device is reported through the Restaurant App so that the third-party validator can change the status of the unique identifier to spoiled. In preferred embodiments, the Restaurant App includes touch screen buttons for each function, including entering the unique identifier for a spoiled tamper proof seal device. All of the process steps ensure that the third-party validator can account for every unique identifier and its status at all times. For added security, the process steps can include taking a photograph of each order after it has been sealed inside the tamper proof packaging with the unique identifier. This step provides photographic evidence that shows that the package has been properly sealed before it was given to anyone for delivery and guards against any allegations that the food was not properly packaged and sealed by the Restaurant User. When the unique identifier has been entered, and all of the process steps are marked completed, then the status of the order is updated to READY FOR DELIVERY and the Restaurant App can automatically send a notification to the driver that accepted the order, to give the unique identifier to the driver and to indicate that the order is ready for pick-up and delivery. The order is then moved from the list of orders that are ACCEPTED BY DRIVER to the list of orders that are READY FOR DELIVERY. When the driver comes to pick up the order, when the driver provides identification to the Restaurant User, the Restaurant User can open the Restaurant App and find all of the orders accepted by the driver. The driver has a mobile application, the “Driver App”, which is described in more detail below, and the driver uses the Driver App to scan the unique identifier for each food container that is to be delivered. This scan can be used to verify that the driver picked up the correct food containers and allows a third-party validator to track when possession of the food container(s) was transferred from the restaurant to the driver. This scan can also trigger the Driver App to send a notification to the Restaurant App to confirm the pick-up, and allow the status of the order in the Restaurant App to change to OUT FOR DELIVERY and to be moved to a list of orders that have been handed over to drivers and that are currently being delivered to customers. When the driver delivers the order to a customer, as confirmed by the driver and/or the customer (as described in more detail below), then the order is moved from the list of orders OUT FOR DELIVERY to a list of COMPLETED ORDERS.

In this example, the second user interface is the Driver App. Drivers can use the Driver App to receive notifications when restaurants have orders with a PENDING ACCEPTANCE status and to manage the delivery process for drivers until food containers are delivered to customers. Drivers can set their preferences to receive notifications from restaurants in a specified area, or specific restaurants by name. Alternatively, in some embodiments the drivers can tap on a button to open a map that shows the driver's real time location and the location of orders PENDING ACCEPTANCE. That is, the Driver App can be set up according to the drivers' preferences for finding orders PENDING ACCEPTANCE using a combination of “push” mechanisms such as notifications, or “pull” mechanisms, like displays of a map or list. When the Driver App shows an order PENDING ACCEPTANCE that a driver wishes to accept, then the driver can tap on the notification, or an order pending acceptance on a map, or an order pending acceptance on a list to accept the order. When a driver accepts an order and when the order is confirmed by the restaurant, the Driver App puts the order onto a list of orders PENDING STORE SCAN and at the same time the Restaurant App changes the status of the order to ACCEPTED BY DRIVER. Once the restaurant changes the status of the order to READY FOR DELIVERY the Driver App receives a notification from the Restaurant App and the Driver App moves the order to a list of orders READY TO PICK UP. When the driver picks up the order from the restaurant the driver can use the Driver App to scan the unique identifier on the tamper proof seal label, and then the Driver App will move the order from the list of orders READY TO PICK UP to a list of orders OUT FOR DELIVERY. At this time the Restaurant App and/or the Driver App can send a notification to the customer to advise that the food order has been picked up. This gives the driver an incentive to make the delivery promptly or at least within a reasonable time, given that customers will understand that drivers can be delivering several food orders at any one time. The notification to the customer can also identify the driver to the customer and over time and repeated orders the customer can become familiar with the drivers working in the customer's area. The Driver App can also suggest a delivery route that optimizes the delivery taking into account other deliveries that the driver is making, and the time each order was made, the time it was picked up, and whether or not the customer indicated a desired delivery time. When the driver delivers the food container to the customer's address if the customer is not present to receive the food, the driver can use the Driver App to take a picture of the address, or to mark the location using GPS, and notify the restaurant and the customer that the driver is at the address for delivery. This can prompt the customer to come to the door and/or the restaurant to contact the customer to check that the address is correct. According to the terms of service, the driver can be authorized to leave the food container at the doorstep after taking photographs to show that the food container has been delivered intact and unopened. Accordingly, the status of the food order can be changed to completed when the customer accepts the delivery or when the driver uploads evidence to show that the food order was delivered intact and unopened.

Just like the Restaurant App interfaces seamlessly with the Driver App, there can also be a desktop or mobile application used by customers, that is, this third user interface in this example being a “Customer App”, through which the customer experience is managed. The Customer App is not required to place a food order. The customer can always place a food order by telephoning the restaurant, ordering through a restaurant's website where the restaurant might have its own online ordering interface, or by some other means. The customer can always leave a mobile number with the restaurant that can be used to send notifications. If the Driver App is used to complete the delivery process and if the customer is notified of the unique identifier by the third-party validator or the restaurant then the method can be fulfilled without the customer needing the Customer App. However, there are advantages of using the Customer App for customers that value all of the security features of the subject method. The Customer App can have a listing of all of the restaurants that have subscribed to the system, so that the customer is assured that all of the restaurants found using the Customer App will deliver the ordered food with such security features, which include the tamper proof seal labels and third-party validation. Customers can use the Customer App to search for restaurants by food type, proximity, price range and other parameters, to select food items to order, and then to place the order. The customer can order food to the be delivered as soon as possible or for a specified time later in the day or on a future date and time. The Customer App can also speed up the ordering process, if customized by the customer to already store the customer's information such as name, preferred delivery address, payment details and favorite restaurants. If the customer prefers to keep this information from being stored in the Customer App this information can be entered with each order and the customer can control what information is stored and what information is given each time. The placement of the order sends a notification to the restaurant, prompting the Restaurant User to enter the order into its system using the Restaurant App. For busy restaurants, using the Customer App can be easier for the customer compared to talking with someone on the telephone. Also, there is less chance for errors in the order by the restaurant which could have a hard time hearing the order if the restaurant is noisy. That is, the Restaurant App can be configured to receive the order information without any transcription by the Restaurant User. Once the food order is received and accepted by the restaurant, the order is managed as described above with respect to the description of the Restaurant App. When the driver picks up the food container from the restaurant a notification that the order has been picked up can be sent to the Customer App so that the customer knows when the food order has been picked up. When the driver arrives at the customer's delivery location, upon receiving the food container the customer can visually inspect the food container to confirm that there is no evidence of tampering and the customer can use the Customer App to scan the unique identifier to confirm that the food container is the correct food container. When scanning the unique identifier, the Restaurant App and the third-party validator are notified that the food container has been delivered, and the status of the order can be changed to COMPLETED ORDER. If the customer sees any damage to the food container or the tamper proof seal label, the customer can take a picture of the damage and upload that to the restaurant and/or third-party validator before scanning the unique identifier so that there is a record of the damage before the food container is opened. Then if there is a problem with the order then the restaurant and the third-party validator will have evidence of the damaged container to help to confirm that the food was compromised during delivery and not by the restaurant. Such incidences can be recorded by the third-party validator and/or the restaurant, to assist in identifying drivers who are frequently associated with such incidences, since this could indicate that these people are less careful in the handling of food containers or other otherwise unreliable and rated as a less desirable option for making deliveries versus other delivery people with better records. By knowing that a poor rating can result in fewer delivery jobs, drivers have an incentive to be careful to avoid damage to the food containers in their care. If the food container appears to be tampered with, the restaurant can give the customer the option of being sent a replacement order.

In the description of these illustrative examples, the delivery people are described as “drivers” but it will be understood that delivery people need not delivery food containers by car or truck. For example, deliveries can be made by delivery people using any type of delivery vehicle, including bicycles, scooters, motorcycles, boat, or even no vehicle at all, if delivery people deliver on foot (in places with high population densities in a concentrated area, in a hotel, or where it can be faster to take transit). That is, the Driver App can be used by any delivery person using any means of transportation.

The Restaurant App, the Driver App, and the Customer App can be configured to work seamlessly with the system of the third-party validator. That is, each of these Apps can be designed to notify the third-party validator's system of any changes in the status for each order, and to associate each order with the unique identifier associated with the tamper proof seal label. This way, the third-party validator knows when an order is picked up by the driver and when the driver delivers the food container to the customer. The system can be set up so that the Customer App is branded with the brand of the third-party validator, and this can help to reinforce the customer's confidence that the unique identifier on the food container matches the unique identifier on record with the third-party validator. To ensure the integrity of the unique identifiers, if any tamper proof seal labels are damaged or somehow otherwise accidentally broken before being deployed, following procedures and training established by the third-party validator, the Restaurant User logs the unique identifiers associated with these spoiled tamper proof seal labels into the third-party validator's database so that they are accounted for and if anyone tries to use the spoiled tamper proof seal labels this can be detected. More than this, the third-party validator's system is designed to check that each unique identifier that is entered into the system is legitimate, for example, by checking to make sure that the unique identifier matches an identifier that has been released to a food source, that the unique identifier matches those unique identifiers that were released to the food source associated with the scanned unique identifier, that the unique identifier has not been previously used, or indicated as having been spoiled or invalid. To accomplish this, the third-party validator's system keeps a record of all of the unique identifiers that have been released, and to whom they were released to, and a database of all of the unique identifiers that have been used.

In some embodiments, a Restaurant User can choose customizable settings. For example, instead of automatically assigning a food order to any driver that accepts the order, the Restaurant User can require that it first confirms a driver's offer to accept the order. In an area where there is an abundance of available drivers, the Restaurant User can view ratings or other feedback for drivers and choose to confirm a driver with a higher rating versus another driver that has a poor rating. In this was a restaurant can establish a pool of drivers that it considers reliable and that its repeat customers can become familiar with.

There can also be mechanisms for cancelling orders from the system. The terms of service for customers can include terms for cancellation of orders. For example, the terms can stipulate that if a customer cancels an order with sufficient notice, more than a predetermined time before a scheduled delivery time, the restaurant will not charge a cancellation fee, but if cancellation is made within the predetermined time period before delivery then the customer can be charged for the cost of the food, and if cancellation is made by the customer after the food order has been assigned to a driver, then the cancellation fee can be the total cost for the food and the delivery charge. When a Restaurant User receives an order cancellation, the Restaurant User opens the Restaurant App and changes the status for the order to CANCELLED so that the order is moved from whichever status list that it is currently listed on, and moves the order to a list of cancelled orders. The Restaurant App can be pre-programmed or customized by the Restaurant User to calculate the cancellation fee based upon the status of the order when the cancellation was made and to reverse the charges to the customer and then charge the customer for the cancellation fee if applicable. If the order had already been accepted by a driver, when the order status is changed to CANCELLED the Restaurant App can be programmed to automatically notify the driver of the change in status and if the order is already out for delivery, the driver then knows that the food container no longer needs to be delivered, sparing the driver from the time and fuel costs for completing the delivery, In accordance with the terms of service, the driver can be paid for the delivery or for a reduced amount based on predetermined parameters such as, by way of example, driver location at the time of cancellation or elapsed time, or time remaining between scheduled delivery time and time of cancellation. The Driver App can also include a means for the driver to cancel acceptance of an order. For example, if the driver's car breaks down or there is an accident that blocks the road between the driver and the restaurant, or there are other changed circumstances that prevent the driver from picking up the food order, the driver can open the Driver App and access a list of accepted orders and cancel the ones that can no longer be fulfilled. When the Restaurant App receives a driver cancellation then the order will be moved back to the list of orders PENDING ACCEPTANCE so that another driver can accept the order. To discourage driver cancellations without good reason, the Restaurant App can keep track to drivers who have cancelled accepted orders so that if a restaurant feels that a driver is unreliable they can refuse to confirm future acceptances of orders from that driver, and in some embodiments the Restaurant App can be customized by the Restaurant User to block unreliable drivers from accepting food orders. The Apps can include an appeal process to remove a poor rating if the driver can provide proof of the reasons for cancelling, for instance if the driver has a medical emergency.

If the driver has already picked up a food order and is delayed in making the delivery because of roads blocked by an accident or construction, the driver can open the Driver App using a voice interface and indicate that the delivery for a food order will be delayed. The Driver App will then communicate this to the Restaurant App and/or to the customer through the Customer App. In some embodiments the driver can also communicate through the Driver App the reason for the delay and an estimated time for delivery so that the customer will know that the food is still on the way, why it has been delayed and when to expect it.

In another illustrative example, similar Apps can be used when food orders are placed by the customer through an intermediary delivery service. That is, instead of the customer ordering food directly from a restaurant, the customer can order food through a delivery service that manages food orders from a plurality of restaurants, grocery stores and other food sources. In this case, a delivery service uses a Delivery Service App, that receives food orders placed by customers. The Delivery Service App can be accessed by customers to order food from all food sources that sign up with the delivery service, including food sources that use the subject method for securing delivered food and food sources that do not use this method, with the Delivery Service App indicating which food sources include this feature and those that do not. In some embodiments, the customer interface with the Delivery Service App replaces the Customer App, and the Delivery Service App interfaces with the Restaurant App and the Driver App and the third-party validator system. In other embodiments the third-party validator can be integrated with the delivery service so that the Delivery Service App is part of the third-party validator's system that tracks food orders, their status and location. The Delivery Service App can keep track of every unique identifier and the status of each order from the time the order is placed until the order is delivered and the status is recorded as COMPLETED ORDER.

With all of these examples, a delivery person can only access the food that is being delivered by breaking the seal or damaging the packaging or food container. This deters delivery people from attempting to open the food containers because they know that it will be detected. The delivery person will know that the customer knows that the tamper proof seal label was applied before the food container was picked up by the food delivery person. This means that if the food appears to be tampered with and the packaging or the tamper proof seal label has visible indications of being damaged, the customer can prove that the delivery person was responsible. On the other hand, if a customer gets sick from consuming delivered food, and the packaging and tamper proof seal label did not show any signs of being compromised, then the customer can complain to the food source, knowing that the food could not have been tampered with by the delivery person.

Any of the above tamper proof seal labels can be integrated with other devices for increased functionality. For example, a GPS tracking unit could be integrated so that the location of the food container can be tracked during delivery, as an additional means of determining if there have been any unusual delays in the course of delivery. When the locking device is a padlock-style mechanism, other technologies that can be combined, such as RFID or electronic code locks as further assurance that only the customer can open the padlock.

While the illustrated embodiments show particular examples, various modifications and alterations can be made to the examples within the scope of the claims and aspects of the different examples can be combined in different ways to achieve further examples. The term “tamper proof” in the context of this disclosure will be understood to mean that the customer will be able to see visual evidence of tampering if there are any visible indications of damage to the food container or the tamper proof seal label. That is, even with the tamper proof seal label applied to the food container, there is no absolute prevention of tampering and a delivery person could still break open the food container or break the tamper proof seal label, and tamper with the food, but the disclosed method prevents this from happening without visible evidence of unauthorized access to the contents of the food container. While several non-limiting examples of different types of food containers have been described, a food container could also include a cup carrier.

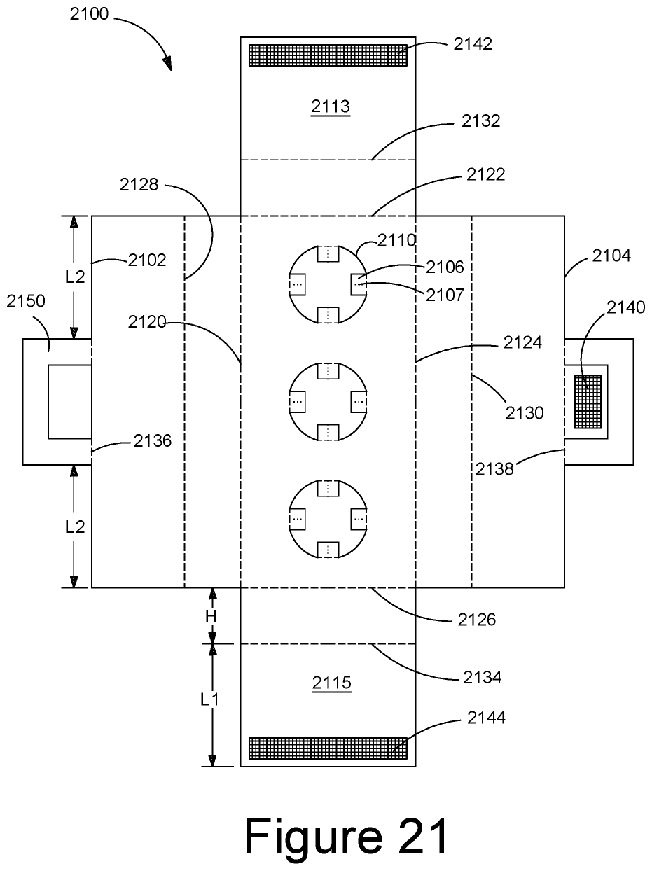

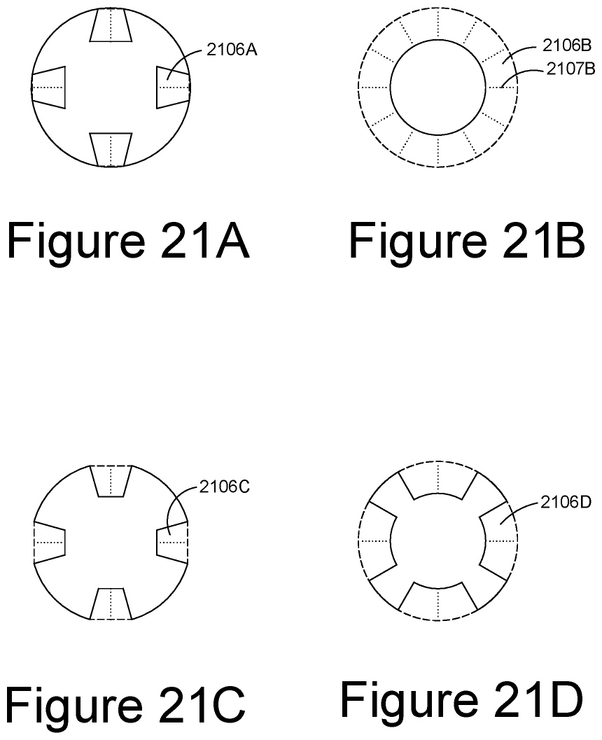

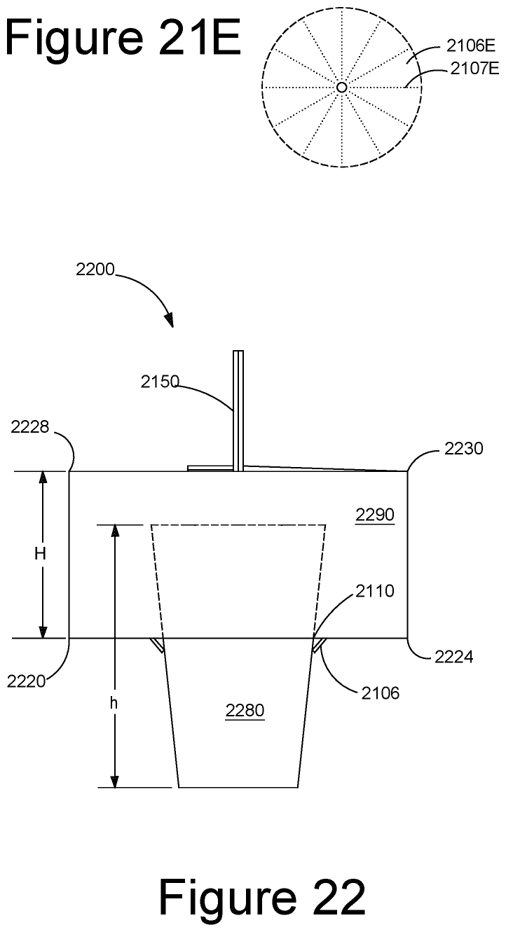

With reference to the diagram in FIG. 21, paperboard blank sheet 2100 is cut and creased along the dotted lines where it will be folded to assemble the carrier. Paperboard blank sheet 2100 can be delivered to restaurants, food trucks and coffee shops as flat unfolded sheets so that they are easy to store without taking up too much space. When a cup carrier is needed it is easy for restaurant workers to assemble it, for example, by placing the cups already filled into hole cut-outs 2110 and then folding first along crease lines 2120, 2122, 2124 and 2126 to create the side walls. Then handle 2150 is folded back along crease lines 2136 and 2138 so that handle 2150 will be oriented up from the top of the assembled cup carrier after sheet 2100 is folded along crease lines 2128 and 2130. At this point in the assembly steps, the non-stick cover to adhesive strip 2140 can be removed. When paperboard blank sheet 2100 is lifted, the sides of the cups come into contact with tabs 2106. Tabs 2106 enable hole cut-out 2110 to accommodate cups with different profiles, since tabs 2106 will bend to conform to the diameter of the cup. Cups of different sizes can have different profiles. For example, a small cup can be shorter than a large cup, but it can also have a smaller diameter. Most cups have a tapered profile with the diameter of the cup being smaller at the bottom. Tabs 2106 can optionally have perforations 2107 that can be torn to allow a better fit with the cups. To continue the assembly, sheet 2100 is folded along crease lines 2128 and 2130 to cover the tops of the cups, when sheet edge 2102 meets edge 2104, adhesive strip 2140 holds sheet edges 2102 and 2104 together. With sheet 2100 having already been folded along crease lines 2136 and 2138, the two sides of handle 2150 are then joined. In the illustrated example the side of handle 2150 on the left side of the drawing has its center punched out to make a hand hold. On the right side of the drawing, the other side of handle 2150 has its center cut on three sides but not punched out, so that the center is used as a tab with adhesive strip 2140 to help to seal the top of the cups inside the assembled cup carrier. Assembly of the cup carrier is completed by peeling off the non-stick covers to adhesive strips 2142 and 2144, folding the sheet along crease lines 2132 and 2134 until adhesive strips 2142 and 2144 are stuck onto the top surface of the cup carrier. Once the cup carrier is assembled, the cups are securely held with the carrier providing a tamper proof barrier that physically prevents access to the tops of the cups, now sealed within an enclosed space defined by a bottom, four sides and a top. The adhesive is chosen to be a type that forms a bond that cannot be broken without tearing the carrier or otherwise damaging the carrier such that it would be visually obvious to the customer that the carrier had been opened. The paperboard blank sheet can have a layered composite structure that has a surface layer that adheres strongly to the adhesive so that it will tear if anyone tries to gain access to the enclosed space. Paperboard blank sheet 2100 has three-hole cut-outs 2110 that are on the bottom of the assembled carrier. The tops of the cups are opposite the top of the enclosed space so the cup lids cannot be accessed through the holes in the bottom without visible damage to the carrier and/or noticeable spillage of the cup contents. A carrier with three openings is flexible for carrying one, two or three cups because it allows the assembled carrier to be balanced when carrying one cup in just the middle spot, two cups in the two outer spots, or three cups by occupying all three spots. Another feature of the disclosed cup carrier is that paperboard blank sheet 2100 is simple and easy to manufacture from one sheet and without any tabs or other paperboard pieces that need to be glued onto the single sheet. To be manufactured, paperboard blank sheet 2100 is cut, creased, and the adhesive strips with non-stick covers are applied. Hole cut-outs 2110 can all be pre-cut, or they can be partially cut or perforated but still attached. If only partially cut or perforated, if a three-cup carrier is used to deliver two cups, then two of the hole cut-outs can be easily punched out, and the third hole cut-out left unpunched so that it remains closed to block access to the enclosed space. In an alternative approach, if a carrier with a plurality of hole cut-outs is assembled with a lesser number of cups than the number of pre-cut hole cut-outs, the assembler can optionally install cover panels to block access to the enclosed space through the hole cut-out. Such cover panels can be provided with a strong adhesive strip or adhesive tape can be applied by the assembler.

The simplicity of the design for the carrier reduces the manufacturing costs compared to carriers that are made from more than one sheet, or that have sections glued on, or sections of itself pre-glued to itself. In assembled form, the externally facing surfaces are on one side of the sheet so that it is easy to print advertising or brands onto just one side of the sheet. The printed side can also be made with a surface treatment that will tear or be otherwise visibly damaged if anyone attempts to open the cup carrier on its way to being delivered to the customer.

In this embodiment, the length of the end wall sections has a length L1 between crease lines 2132 and 2134 and the respective outer edges that is equal to, or less than length L2. If L1 is equal to L2, then when the cup carrier is assembled, areas 2113 and 2115 will cover the gap between sheet edges 2102 and 2104 up to handle 2150, and adhesive 2140 seals the gap under the handle. Dimension H corresponds to the height of the enclosed space when the carrier is assembled. Dimension H is the same dimension between crease line 2120, 2122, 2124 and 2126 and respective crease lines 2128, 2132, 2130 and 2134.

In FIG. 21, each hole cut-out 2110 is shown with four tabs 2106 that have square corners and that extend into the opening so that different sized cups can be gripped by the same hole cut-out. By way of example, FIGS. 21A, 21B, 21C, 21D and 21E show other hole cut out designs that have differently shaped tabs or perforations, demonstrating that the shape of hole cut-outs 2110 and tabs 2106 is not limited to the illustrated shapes. In FIG. 21A tabs 2106A have a trapezoidal shape with the tabs getting wider as they extend into the opening. In FIG. 21B there is no spacing between tabs 2106B. Perforations 2107B can be torn to bend tabs 2106B to make the opening larger. In other embodiments, cuts can be substituted for some or all of perforations 2107B to make it easier to bend tabs 2106B. FIG. 21C shows another embodiment with tabs 2106C being trapezoidal-shaped with the tab tapering to a smaller width as it extends towards the center of the opening. FIG. 21D shows yet another embodiment, similar to that of FIG. 21C except that the free edge of tab 2106D that faces the center of the opening is curved so that more of this edge will be in contact with the side of a cup. FIG. 21E shows an embodiment that defines an opening that is substantially closed until it is punched out by breaking the sheet along perforations 2107E so that segments 2016E can be bent out of the way so that a cup can be held in the assembled carrier. This embodiment provides more security when the carrier is used to carry fewer cups than there are spaces, and in such times, the carrier can be used to carry food items in addition to cups, because when perforations 2107E are not broken, for an opening that is not being used, there is no hole in the bottom of the carrier, so other food items will not fall out, and when deposited into the enclosed space, these other food items will also be securely transported. Cups typically have a circular horizontal cross section shape, so the hole cut-outs are generally circular, but hole cut-outs with different shapes can be used to hold cups that are shaped differently. For example, a popcorn box with a square lateral cross-section can be securely held in a circular opening if the sides of the popcorn box are tapered, or a carrier for popcorn boxes can be made with square-shaped openings and still be in the spirit of the disclosed carrier.

Paperboard blank sheet 2100 can be made from any material that has the requisite strength to carry the filled cups and enough stiffness that it will not be deflected and lose its shape when used to transport the filled cups. By way of example, corrugated cardboard has been found to be a suitable material and it is inexpensive enough to be used as a disposable carrier that can be recycled, and that is bio-degradable if not recycled. However, other materials with the requisite strength and stiffness can be substituted. A carrier that is inexpensive and disposable is a convenience for carriers that are used for deliveries because it can be inconvenient for the customer to go back to the restaurant to return the carrier since this negates some of the advantage of getting the drinks delivered. That said, people are becoming more environmentally conscious and responsible. By way of example, a money-based deposit system could be implemented to give incentives to the customers to return carriers, and with such a system in place, the carriers can be made from materials that would be durable enough to be re-used. Some restaurants may see a re-usable cup carrier used by customers upon payment of a deposit as an incentive for customers to come to the restaurant or to re-order delivery. Some food sources can print advertising on the carriers so that when in use, people seeing the carriers will see the advertising, and it will help to identify the carriers for safe return. Even if the carriers are not returned, and consumers continue to use the carriers to carry cups or other food items, the advertiser can benefit from the advertising.

FIG. 22 depicts an end view of a carrier for secure cup delivery that has been assembled from the paperboard blank sheet of FIG. 21. Corners 2220, 2224, 2228 and 2230 correspond to respective crease lines 2120, 2124, 2128 and 2130 shown in FIG. 21. Handle 2150 is shown in it folded up position where it can be used as a hand hold for carrying cup carrier 2200 with one hand. Cup carrier 2200 can carry between one and three cups in a row, using the hole cut-outs shown in FIG. 21. From the end view, only one cup 2280 can be seen. The outline of cup 2280 is shown in dashed lines where the top of the cup is held within enclosed space 2290 inside cup carrier 2200. Hole cut-out 2110 is sized so that cup 2280 will not fall through. For a smaller cup, tabs 2106 can remain horizontal, but for larger cups tabs 2106 can bend down, as shown in FIG. 22, to hold cup 2280 securely. In preferred embodiments, cup carrier 2200 is dimensioned with height H that gives room for it to accommodate cups of different sizes, but with height H being less than the height of the smallest cup size used by the restaurant or other user; this way the top of cup carrier 2200 prevents the cup from being pushed out from hole cut-out 2110, for example, if cup carrier 2200 and the carried cups are set down on a table or counter. That is, cup carrier height H prevents even the smallest cups from leaving hole cut-put 2110 after cup carrier 2200 is assembled, and so long as cup carrier 2200 is kept upright, cup 2280 will not tip over. This is achieved by cup carrier height H being less than cup height h for the shortest cup that cup carrier 2200 is designed to carry. FIG. 22 shows that once assembled, cup carrier 2200 completely covers and surrounds the tops of the cups, which are held in enclosed space 2290 so that access to whatever is being delivered in the cups is physically blocked, preventing anyone from accessing the tops of the cups and the contents of the cups without breaking open cup carrier 2200. The cup carriers described herein can be used for the secure delivery of beverages, but the contents of the cups could be anything that is packaged by a business and delivered to a customer in a cup or cup-shaped container, and could include, for example, food or legal marijuana.

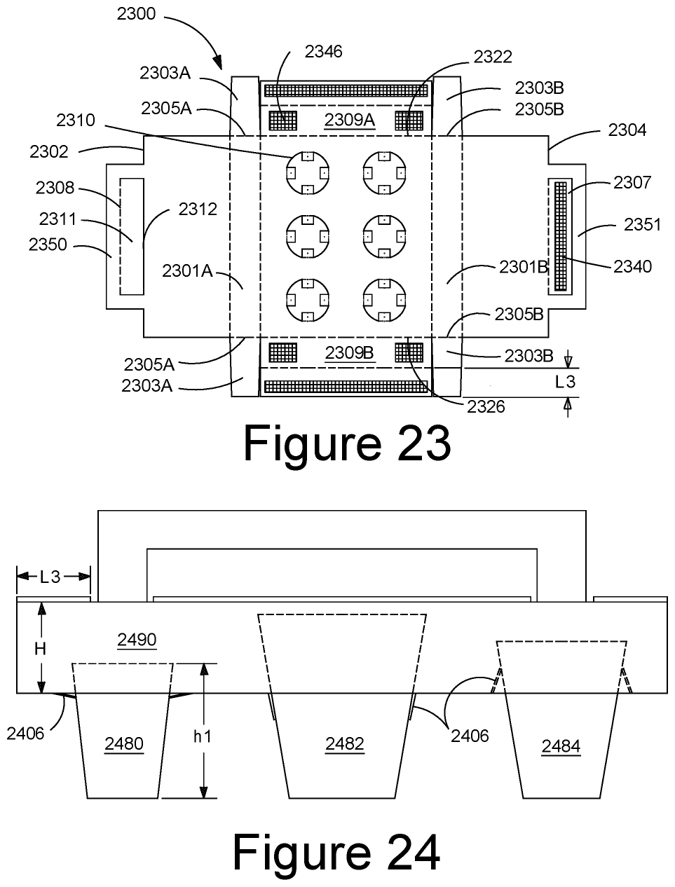

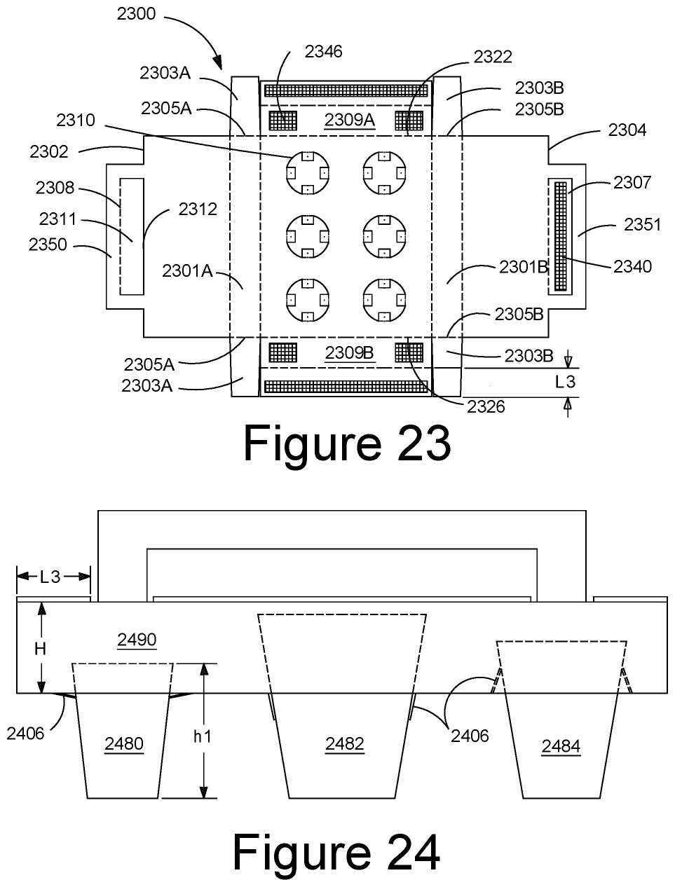

FIG. 23 illustrates paperboard blank sheet 2300 that has hole cut-outs 2310 for carrying six cups. In this embodiment the creases indicated by the dashed lines are functionally the same as those in the embodiment of FIG. 21, and the assembly of the cup carrier made from blank sheet 2300 will not be described except to describe features and functions that are different in this embodiment. Blank sheet 2300 shows that cup carriers within the spirit of this disclosure can be made in different sizes and configurations to hold a different number of cups. Hole cut-outs 2310 are still generally circular in shape and cut with tabs 2106, but in this embodiment, there are six-hole cut-outs in a two-by-three configuration, meaning that there are two rows of hole cut-outs with each row having three-hole cut-outs. In this embodiment, side walls 2301A and 2301B have respective extensions 2303A and 2303B, and crease lines 2305A and 2305B. Before end walls 2309A and 2309B are folded along respective crease lines 2322 and 2326, extensions 2303A and 2303B are folded in along respective crease lines 2305A and 2305B so that these extensions extend along the inside of end walls 2309 when the cup carrier is assembled. These extensions 2303A and 2303B at each corner of the cup carrier serve as a further physical barrier for blocking access to the interior space defined by the assembled cup carrier. Optional adhesive strips 2346 can be used in some embodiments to hold extensions 2303A and 2303B in position against end walls 2309A and 2309B and thereby further strengthen the structure of the assembled cup carrier by reinforcing the corners. By positioning adhesive strips 2346 on sections 2309A and 2309B, then all of the adhesive strips are positioned on one side of blank sheet 2300, facilitating manufacturing. In some embodiments, the reinforced corners can enable the use of a lighter weight paperboard. In other embodiments, it can be more desirable to keep assembly of the cup carrier simpler and faster, and adhesive strips for the corner extensions are not necessary because cups held in the corner positions will prevent extensions 2303A and 2303B from being pushed away.

FIG. 23 also shows another optional feature with regard to the handle design. In this embodiment area 2311 is not punched out but is instead cut on three sides as depicted by solid lines 2312, and creased, but not cut, along dashed crease line 2308. Area 2311 is lifted up and away from the plane defined by paperboard sheet 2300 so that when left handle 2350 is brought next to right handle 2351, area 2311 can pass through the opening of right handle 2351 and be folded up flat against the outward facing surface of right handle 2351, providing a smooth gripping surface for the person holding the handle, instead of the two edges of the punched out handles 2350 and 2351. At the same time, area 2307, which has adhesive strip 2340, is inserted through the opening of left handle 2350 and attached to the top of cup carrier to hold sheet edge 2302 next to sheet edge 2304. In this embodiment, left handle 2350 and right handle 2351 are also made longer so that adhesive strip 2340 seals most of the gap between sheet edges 2302 and 2304, which allows length L3 to be shorter compared to length L1 in the embodiment of FIG. 21.

FIG. 24 depicts a side view of a carrier for secure cup delivery that has been assembled from paperboard blank sheet 2300 of FIG. 23. In the side view of FIG. 4, the outline of three cups 2480, 2482 and 2484 are shown. To demonstrate how this cup carrier facilitates carrying cups of different sizes, each of the three cups is a different size. Cup 2482 is the largest, and cup 2480 is the smallest. The cup carrier has height H which facilitates carrying a range of cup sizes by allowing space for the tops of different cup sizes to be held in the sealed and enclosed space 2490, while the bottoms of all of the cups can be at the same level, which makes it easier to set the carrier down on a level counter or table with all of the cups supported and without any of the cups tipping over. Cup carrier height H is less than cup height h1, which is the height of cup 2480, which is the smallest and shortest cup. Since cup 2480 has the smallest diameter, in this example tabs 2406 can remain almost horizontal (as shown) or could be bent slightly upwards as they are for medium size cup 2484, as an extra precaution to prevent the cup from falling through hole cut-out 2310. Instead of a circular hole without any tabs, tabs 2406 enable a snug fit with a range of cup sizes, by changing how much tabs 2406 are bent. The hole cut out is also sized to accommodate cup 2482 which is the largest cup size, by making the hole cut-out large enough to receive cup 2482 to a point where the top of this cup is within enclosed space 2490 by ensuring that the diameter of the hole cut-out is at least as large as the horizontal cross-sectional diameter of cup 2482 a distance H from the top of cup 2482. In the embodiment of FIG. 24, when cup 2482 is inserted into the hole cut out, tabs 2406 in the hole cut-out have been bent completely out of the way so that this is the maximum cup diameter that can be accommodated.

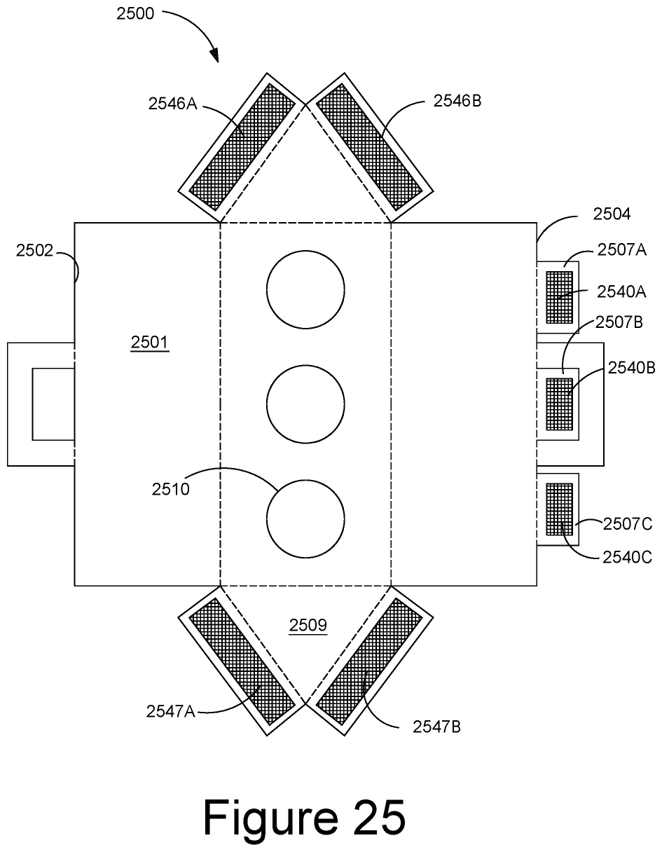

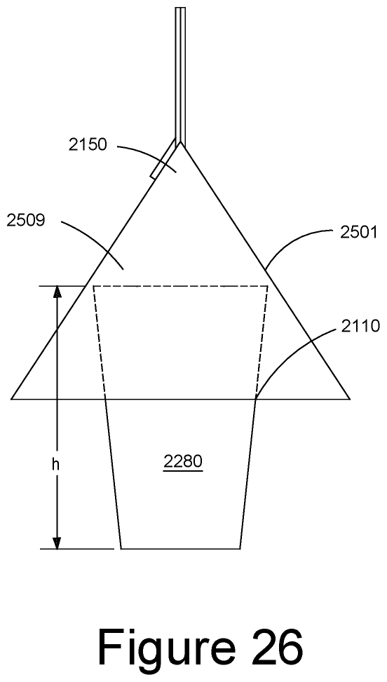

FIGS. 25 and 26 illustrate a third embodiment that demonstrates that the carrier can be made in different shapes, that can give the carrier a more distinctive look, which can become associated with secure drink delivery and/or a certain restaurant, while still providing all of the functionality of the other embodiment to discourage unauthorized access to the cup contents for improved security during delivery. As shown in FIG. 25, paperboard blank sheet 2500 has three-hole cut-outs 2510 for carrying three cups, like the embodiment of FIG. 21. Like in the other figures, the creases indicated by the dashed lines function in the same manner to facilitate assembly. However, in this embodiment, when assembled, as shown in the end view of FIG. 26, the sides are sloped and not vertical. End walls 2509 can be vertical, but when sides 2501 are folded they meet in the middle to form sloped roof panels as shown in FIG. 26. This alternative embodiment also shows that hole cut-outs 2510 can be round and without any tabs. Some restaurants use fewer cup sizes or use cups that have a similar diameter so that tabs are not necessary. With the sloped roof design, end walls 2509 cannot fold over to cover the gap between edges 2502 and 2504 of side sections 2501 like they do in the embodiment of FIG. 21. FIG. 25 also shows that a cup carrier can be made with extra assembly tabs and adhesive strips to better seal the gap between sheet edges 2502 and 2504 of the assembled cup carrier. Tabs 2507A, 2507B and 2507C, each having a respective adhesive strip 2540A, 2540B and 2540C. Alternatively, handle 2550 can be made longer, similar to the handle shown in FIG. 23 so that adhesive strip 2540B for tab 2507B underneath the handle seals most of the top edge where the sloped sides meet. An advantage of the triangle shape is that less folds are required to assemble the carrier end walls 2509 can comprise tabs with adhesive strips 2546A, 2546B, 2547A and 2547B that can be used to seal the edges where end walls 2509 meet sloped sides 2501, so that extensions like those described in relation to the embodiment of FIG. 23 are not needed to seal and reinforce the corners.

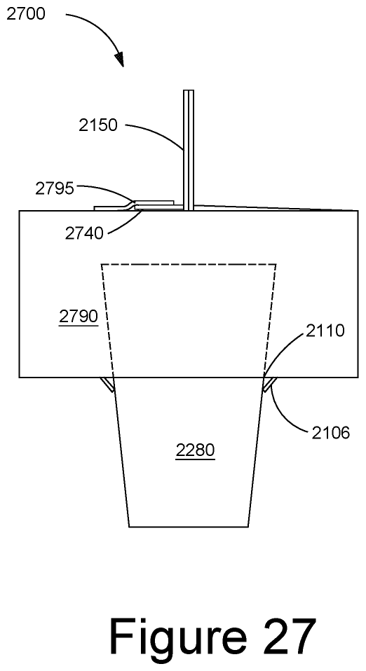

With reference to FIG. 27, a re-usable cup carrier is shown. Re-usable cup carrier 2700 can be assembled in essentially the same way as the other embodiments, and parts that are the same are indicated with the same reference numbers as in other embodiments. A difference is that a different sealing mechanism is needed, and a re-usable cup carrier is preferably made from a more durable material such as plastic, which will not weaken after repeated use, and that will not degrade if subjected to drink or food spills or wetness from rain or exposure to other substances encountered by normal use. Releasable and re-usable closures 2740 such as hook and loop fasteners (also known by the tradename Velcro™), or a re-adherable strip of glue, for example, a low-tack pressure sensitive adhesive. However, such releasable and re-usable closures only help with assembly and to hold cup carrier 2700 in its assembled configuration. These releasable closures will not provide the security feature that is provided by the adhesive strips shown in the other embodiments. To provide the security of a sealed cup carrier for a re-usable cup carrier, after it is assembled, seals 2795 are applied to prevent the re-leasable closures from being opened while the cups are being delivered. Seals 2795 can use one or more mechanisms that will give a visible indication if the cup carrier has been opened when being delivered. For example, seal 2795 can be an adhesive label made from a material that will tear or that will stretch and deform if anyone tries to remove it. Seal 2795 can be made with cuts or perforations that will tear the seal into pieces as a visual indication if anyone tries to remove it. Other tamper proof seal technologies, such as any of those described above for food packaging can be used to prevent a re-usable cup carrier from being opened in the course of delivery, by means of a latch-type closure formed in the sheet blank to cooperate with a self-locking loop, a padlock, or a cord loop sandwiched between a tamper proof seal label, so that like the other embodiments, once the cup carrier is assembled, once a sealing mechanism is applied, it defines a secure and enclosed space 2790 for the tops of the cups, establishing a physical barrier during delivery that gives visible evidence of tampering if access is attempted.

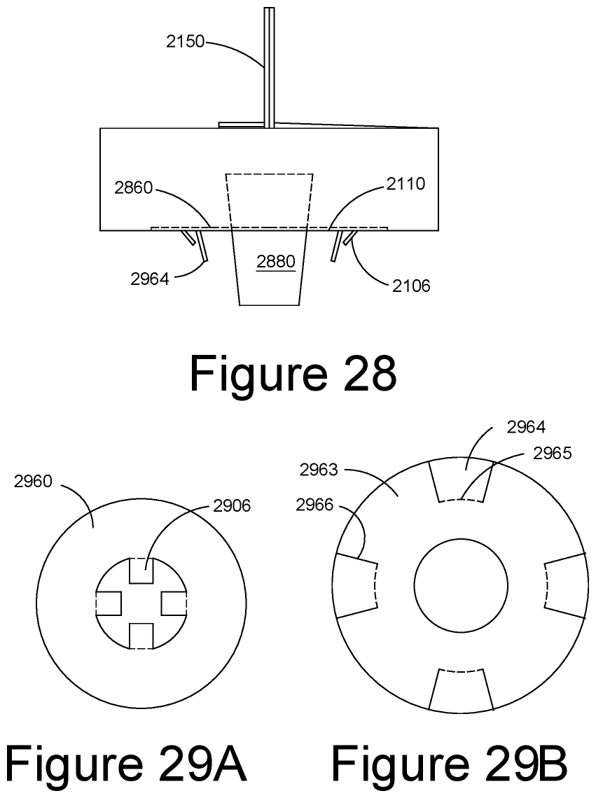

For reducing manufacturing costs, it is best for the manufacturer of the paperboard sheet blanks to be able to sell the same sheet blanks to many different customers. However, there may be some customers that have cup sizes that are smaller than the smallest cup size used by most customers. It might be impractical to size the hole cut-outs for the smallest cup size when this is not the ideal size for most customers. FIG. 28 is a cross-section end view of a cup carrier that shows an embodiment that solves this problem by installing adapter ring 2860. For a customer that has a cup size that is smaller than most cups and small cup 2880 is at risk of falling through the hole cut-out, adapter ring 2860 provides the support needed for securely holding small cup 2880 in the assembled cup carrier.

FIG. 29A is a top view of one embodiment of an adapter ring that can be inserted like adapter ring 2860 in FIG. 28. In this embodiment adapter ring 2960 is simply a ring that has a hole cut-out that is smaller than the hole cut-out in the cup carrier and that has an outside diameter that is much larger than the hole cut-out of the cup carrier. When deployed, adapter ring 2960 rests on top of the hole cut-out in the cup carrier and prevents small cup 2880 from falling through the hole cut-out in the cup carrier. Adapter ring 2960 can have its own tabs 2906 so that it can hold a range of small cup sizes by controlling how much tabs 2906 are bent. Different tab designs can be used, as shown, by way of example, in FIGS. 21A through 21E. Tabs 2906, when bent down can also extend into hole cut-out 2110, preventing adapter ring 2960 from sliding too far off center from alignment with hole cut-out 2110.

FIG. 29B is a top view of another embodiment of an adapter ring that can be inserted like adapter ring 2860 in FIG. 28. In this embodiment sections 2963 define a diameter larger than the hole cut-out of the cup carrier. Sections 2964 can be pre-cut as shown by cut lines 2966 or can instead have perforated sides. In either embodiment, section 2964 can be bent downwards along crease lines 2965, which are collectively positioned at a diameter that is less than the diameter of hole cut-out 2110 of the cup carrier. In this way, section 2964 extends into the cup carrier's hole cut-out and keeps adapter ring 2960 centered in hole cut-out 2110. Section 2964 is shown extending through the cup carrier's hole cut-out in FIG. 28.

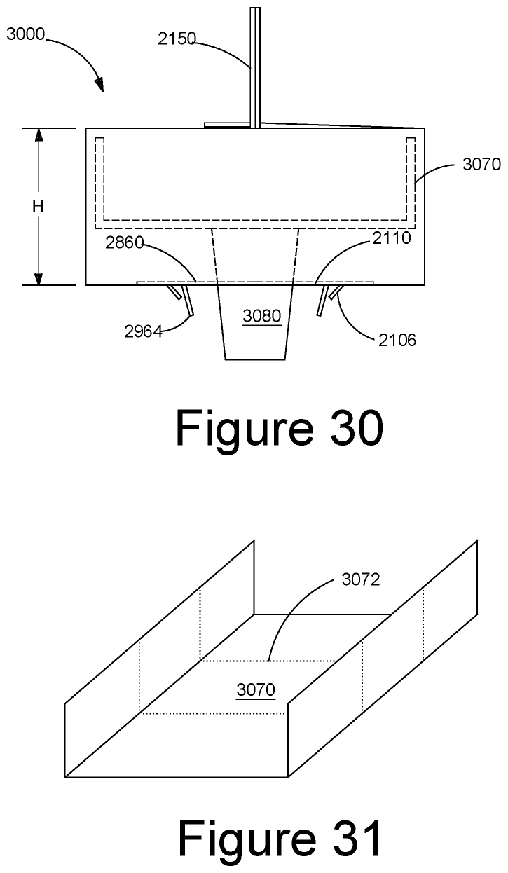

Another way to make a paperboard sheet blank more universal is to provide spacers as shown in the side cross section view of FIG. 30. In FIG. 30, it can be desirable to prevent small cup 3080 from being lifting out of hole cut-out, for example, if the cup carrier is set down on a table. While cup carriers are preferably designed so that for most customers the cup height is greater than side height H of the cup carrier, there can be some customers who use irregular-sized cups. Spacer 3070 allows universal cup carrier 3000 to be adapted for shorter than normal cup sizes. As shown in FIG. 30, spacer 3070 can be combined with adapter ring 2860. FIG. 31 is a perspective view of spacer 3070 that has been folded for insertion into a cup carrier. If just one of the cups is an extra small cup, then spacer 3070 can be torn along perforated line 3072 so that it is sized to be deployed as a spacer for just one cup. Perforated line 3072 divide spacer 3070 into three segments. Perforated lines 3072 are located to divide the spacer sheet into segments, with a single segment being sized to provide spacing for one cup, so that for a six-cup carrier that is being used to deliver six extra small cups, two spacers can be used for a cup carrier that has two rows of three cups to cover all six cups. For illustrative purposes, by way of example, spacer 3070 is configured with three segments to complement the three-cup and six-cup carriers shown in the other embodiments, but other configurations can be used, for example, single segments, two segment spacers and four segment spacers. When a food source purchases cup carriers and spacers from a supplier, both the blank sheets and the spacers are on hand when the cup carrier is being assembled. Spacer 3070 is made to fit the interior dimensions of the assembled cup carrier and this makes the spacer segments adaptable for other uses, such as covering the hole cut-outs so that there are no openings into the enclosed space when a cup carrier is used to deliver fewer cups than the number of hole cut-outs in the carrier. That is, the segments of spacer 3070 can be sized to fit the bottom of the cup carrier with the side folds aligned with side walls so that it difficult to lift out of the way, and to facilitate being fixed in place with some adhesive tape. While the design of spacer 3070 provides this multi-functionality, the concept of the spacer is not limited to just this embodiment. Other spacers known in the food packaging field can be adapted to function in the same way as spacer 3070 for preventing a small cup from being lifted from the hole cut-out. For example, in the packaging for pizzas, some restaurants use a plastic spacer that has three or four plastic legs and a small round “tabletop” that can be inserted inside a pizza box near the middle of the pizza. This spacer prevents the pizza box lid from deflecting and coming into contact with pizza toppings. A similar spacer could be provided with the cup carrier. This spacer could be inverted so that the legs are oriented upward, and the flat round tabletop can be attached to the top of the cup with some adhesive so that it does not slide out of position. Other types of spacers could be substituted for spacer 3070 and combined with the cup carrier to function in substantially the same way to achieve substantially the same result.

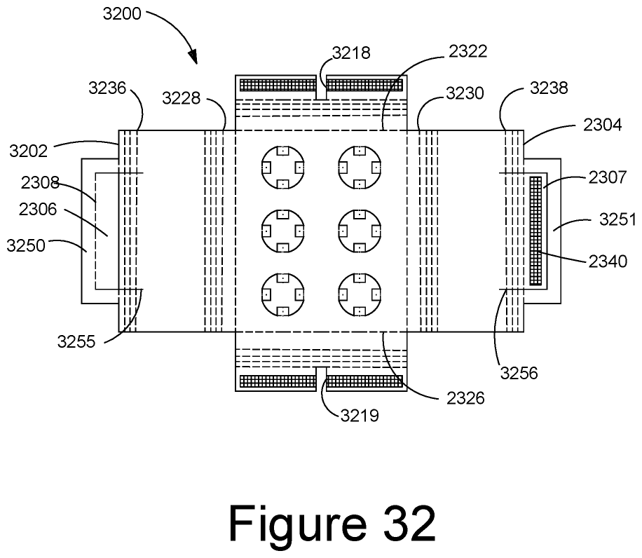

FIG. 32 illustrates a fourth embodiment of a blank sheet for a cup carrier that has additional features for adapting to different cup sizes. The features that are the same as those in other embodiments function in substantially the same way and will not be described again in relation to this embodiment. Only the features that are different from the other embodiments are described in detail. As shown by the dashed lines that indicate parallel and adjacent crease lines in the end and side walls of cup carrier paperboard blank sheet 3200, during assembly, the person who is assembling the cup carrier can select a set of crease lines that define a height for the cup carrier that best fits the cups to be carried. This allows more adaptability of a universal paperboard blank sheet that can be assembled differently for different customer orders to accommodate a range of cup sizes. For restaurant, coffee shops and other establishments that offer beverages in a range of cup sizes, the cup sizes for each customer order are often different. Sheet blank 3200 can be folded to best suit the cup sizes of each particular order. There are also parallel crease lines for other elements affected by the wall height, such as the carrier top panels for folding handles 3250 and 3251. If the lowest crease lines 3228 and 3230 are chosen, then the innermost crease lines 3236 and 3238 are folded so that top sheet edges 3202 and 3204 are both oriented upwards. This will make the handles 3250 and 3251 slightly taller. Cut lines 3255 and 3256 allow the top surfaces underneath the handle to overlap and remain flat so that adhesive strip 2340 still seals the two top pieces of cup carrier 3200 together. Area 2306 can still be folded along crease line 2308 to be wrapped under the grip area of handle pieces 3250 and 3251 to provide a more comfortable hand hold, with cut lines 3255 allowing the more inward section below handle piece 3250 to be folded in the opposite direction so that it can form a seal against adhesive strip 2340. To complete the assembly when the lowest carrier side height is selected, to accommodate the longer dimension of the end flaps that folds over on top of the top surface, and the side parts of the handles which are now oriented upwards, sheet blank 3200 is cut with notches 3218 and 3219.

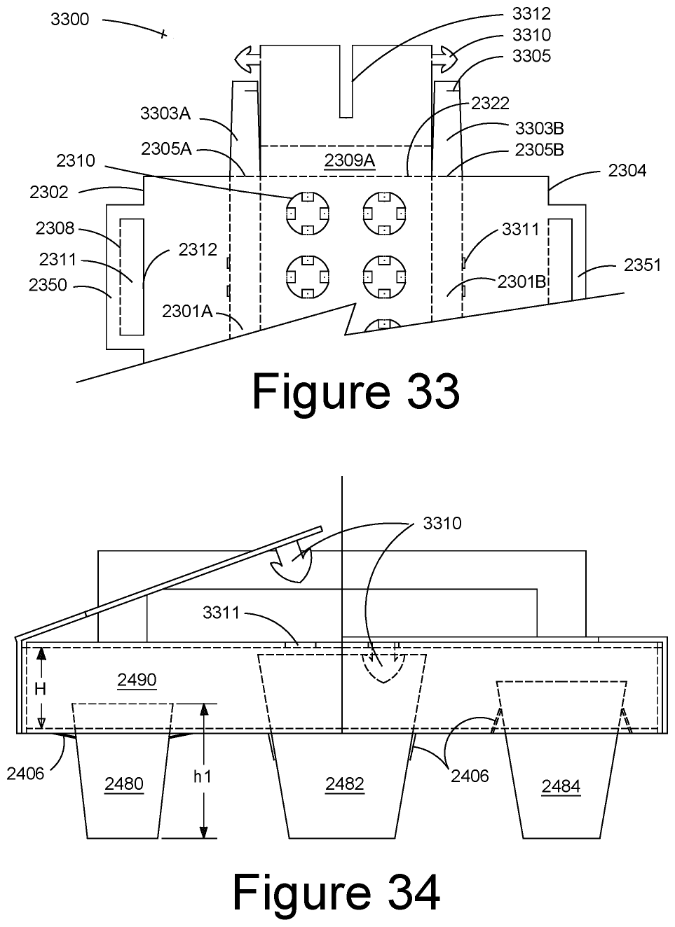

FIGS. 33 and 34 illustrate another embodiment of the carrier that uses tamper-evident pronged tabs 3310 to seal the enclosed space of the assembled carrier instead of, or in other embodiments, in addition to adhesive seals. FIG. 33 is a partial view of a sheet blank, showing the features of this embodiment. The opposite side, not shown, is a substantially the same. When folded and assembled, extensions 3303A and 3303B are folded towards each other and are held together by respective interlocking slots 3305, blocking access into the enclosed space through the corners. Pronged tabs 3310 are attached to the side panels that are folded over to form the top of the enclosed space that surrounds the tops of the cups. Slot 3312 allows these side panels to fold flat around the turned-up handle. The enclosed space is sealed by inserting pronged tabs 3310 into receiving slots 3311. Pronged tabs 3310 have sufficient resilience and strength to deform and be inserted through slots 3311 and the prongs prevent pronged tabs 3310 from being withdrawn from slots 3311 without being visibly damaged. FIG. 34 is a side view of the carrier that shows on the left side, the side panel not yet installed and with a pronged tab 3310 above slot 3311. On the right side, the side panel is fully installed, lying flat with pronged tab 3310 inserted through its respective slot. In accordance with the secure delivery method, after both pronged tabs are inserted, an adhesive seal label can be placed across where the side panels meet, above pronged tabs 3310 as an extra sealing mechanism and to give the carrier a unique identifier (marked on the seal label).

In other embodiments of the platform for the secure delivery and packaging of a food order, the food order can be sealed inside a lockable compartment in a drone or other automated delivery vehicle. The scope of the claims is to be understood from the entirety of the present disclosure in view of, but not limited to the embodiments illustrated and described herein. That is, with the benefit of the teachings of this disclosure it will be apparent that various modifications and variations can be made without departing from the scope of the claims.

What is claimed is:

1. A computer-implemented method for a third-party validator to operate one or more servers to validate secure food delivery for delivering food to a customer from a food source, the method comprising:
the food source following procedures established by the third-party validator for sealing a food order at the food source in a package that prevents access to the food order without visibly damaging the package or breaking a tamper proof seal or a locking device, wherein the tamper proof seal or the locking device is permanently marked or attached to a tag with a unique identifier assigned by the third-party validator, the food source then communicating with the one or more servers through a food source user interface that is connected to a communication network to upload the unique identifier;
the one or more servers comprising one or more processors and a memory that stores a set of instructions and a digital database, the one or more processors use the instructions to:
receive the unique identifier uploaded by the food source, validate that it is authorized by referencing the digital database and confirming that the unique identifier was assigned to the food source by the third-party validator and not previously deployed or marked as used;
if the unique identifier is not authorized because it does not match with a unique identifier assigned to the food source in the digital database or because it matches with a unique identifier that was previously deployed or marked used, automatically alerting the food source;
if the unique identifier is confirmed to be authorized, then marking the unique identifier as deployed and unavailable to be used again:
the customer, upon receiving delivery of the food order, inspects the package and the tamper proof seal or locking device to be assured that the food order is secure and reports the unique identifier to the third-party validator through a customer user interface connected to a communication network; the one or more processors using the instructions to complete the method by:
checking that the unique identifier uploaded by the food source matches the unique identifier reported by the customer, and if there is a match, communicating to the customer through the customer user interface, validation that the food order was securely delivered and marking the unique identifier as used in the digital database, and if the unique identifiers do not match, communicating this to the customer and indicating that the secure delivery of the food order is not validated; and
storing a record in the digital database to record whether or not the unique identifiers matched and what was communicated to the customer.

2. The computer-implemented method of claim 1, further comprising the food source collecting the name and/or other identifying information from a person that picks up the package and also uploading this information and the time when the package was picked up to the one or more servers.

3. The computer-implemented method of claim 2 further comprising the processor automatically reporting to the food source when a food order delivery has been completed or when the unique identifiers do not match and a secure delivery cannot be validated.

4. The computer-implemented method of claim 1 further comprising the third-party validator supplying tamper proof seals or locking devices to the food source and entering into the digital database the unique identifiers marked on each respective tamper proof seal or locking device and associating the unique identifier with the food source.

5. The computer-implemented method of claim 1, further comprising a delivery person using a computer with a program that has a delivery person user interface to communicate with the one or more servers and to capture and send to the one or more servers at least one photograph of the unique identifier and sealed packaging, and to automatically send location confirmation determined by GPS data, as a secondary or alternate confirmation of the secure delivery of the food order, and wherein said one or more servers stores the at least one photograph and location confirmation in the digital database together with a time recorded when the delivery was confirmed.

6. A computer-implemented platform for a third-party validator to validate secure food delivery for delivering a food order to a customer from a food source, the platform comprising:
a food source computer having a program with a food source user interface for uploading a unique identifier for the food order to one or more servers that are operated by the third-party validator, the unique identifier being permanently marked on a tamper proof seal or locking device that prevents packaging for the food order from being opened without evidence of tampering;
the one or more servers comprising a processor and a memory that stores instructions for the processor to:
receive the unique identifier from the food source computer, validate that the unique identifier is authorized by referencing a digital database and confirming that the unique identifier was assigned by the third-party validator to the food source and that it is available and not previously deployed or marked used;
if the unique identifier is not authorized, automatically alerting the food source;
if the unique identifier is confirmed to be authorized, then marking the unique identifier as deployed and unavailable to be used again;
a customer computer having a program with a customer user interface for:
communicating with the one or more servers and reporting the unique identifier associated with packaging for the food order that is received;
the processor then comparing the unique identifier reported by the customer and the unique identifier uploaded by the food source; if there is a match, confirming to the customer that the security of the food order is validated and marking unique identifier as used in the digital database; and, if there is no match, communicating to the customer that the security of the food order cannot be validated because the reported unique identifier does not match with the unique identifier uploaded by the food source, and marking both of the two different unique identifiers as used in the digital database, storing in the digital database a record of the food order and particulars thereto the failed validation, and automatically sending a copy of the record to the food source.

7. A computer-implemented automated method enabled by one or more servers operated by a third-party validator to validate secure food delivery for food orders delivered to a customer from a food source, the one or more servers comprising one or more processors and a memory that stores a set of instructions and a digital database, the one or more processors using the set of instructions to:
receive a unique identifier and contact information for the customer from a food source, the food source representing to the third-party validator that the unique identifier is permanently associated with a tamper proof seal or locking device that ensures that packaging for the food order prevents anyone from accessing the food order without damaging the packaging or the tamper proof seal or locking device,
validate that the unique identifier received from the food source is authorized by referencing the digital database and confirming that the unique identifier was assigned to the food source by the third-party validator and that it was not previously used;
if the unique identifier received from the food source is not authorized because it does not match with a unique identifier in the digital database or because it matches with a unique identifier that was previously used, automatically alerting the third-party validator and the food source;
if the received unique identifier received from the food source is confirmed to be authorized, then marking the unique identifier as used and unavailable to be used again, and using the customer contact information to communicate the unique identifier to the customer;
receive a communication from the customer confirming one of:
(a) food order received sealed and secure
(b) food order received compromised or damaged
(c) food order not received; and
store a record in the digital database to record the communication from the customer.

8. A computer-implemented method for third-party validation of secure delivery of a food order by an intermediary from a food source to a customer, the system comprises computer-implemented procedures established and controlled by a third-party validator that are followed by the food source and the intermediary; the method comprising:
the third-party validator assigning a unique identifier to the food source that the food source attaches to a food order that is deposited in a sealed tamper-proof package;
the third-party validator providing a food source user interface computer program to the food source to provide a means for the food source to use a computer to report the unique identifier attached to the food order to a third-party validator computer;
the third-party validator providing an intermediary user interface computer program to the intermediary to provide means for the intermediary to use a computer to communicate to the third-party validator computer, information relating to picking up the food order and to confirm when the food order is delivered to the customer.

9. The computer-implemented method of claim 8 wherein all communications between the third-party validator computer and the food source user interface computer program and the intermediary user interface computer program are date and time stamped and saved in a digital database.

10. The computer-implemented method claim 8 wherein the food source user interface compute program requires procedural steps determined by the third-party validator to be completed before the food source can advance to handing possession of the food order to the intermediary, and one of these procedural steps includes uploading a photograph of the sealed food order with the unique identifier attached.

11. The computer-implemented method of claim 8 wherein intermediary user interface computer program requires the intermediary to take a photograph of the sealed food package at the delivery address and to upload the photograph to the third-party validator computer to complete the confirmation of the delivery.

12. A computer-implemented method for third-party validation of secure delivery of a food order by an intermediary from a food source to a customer, the system comprises computer-implemented procedures established and controlled by a third-party validator that are followed by the food source and the intermediary; the method comprising:
the third-party validator assigning a unique identifier to the food source that the food source attaches to a food order that is deposited in a sealed tamper-proof package;
the third-party validator providing a food source user interface computer program to the food source to provide a means for the food source to use a computer to report to the third-party validator the unique identifier attached to the food order;
the third-party validator providing a customer user interface computer program to the customer to provide means for the customer to use a computer to communicate with the third-party validator to confirm receipt of the food order, and whether or not the food order was secure when delivered.

13. The computer-implemented method of claim 12 wherein all communications between the third-party validator computer and the food source user interface computer program and the customer user interface computer program are date and time stamped and saved in a digital database.

14. The computer-implemented method claim 12 wherein the food source user interface compute program requires procedural steps determined by the third-party validator to be completed before the food source can advance to handing possession of the food order to the intermediary, and one of these procedural steps includes uploading a photograph of the sealed food order with the unique identifier attached.

15. The computer-implemented method of claim 12 wherein customer user interface computer program requires the customer to take a photograph of the sealed food package at the delivery address and upload the photograph to the third-party validator computer to complete the confirmation of the delivery.
